(19) United States
(12) Patent Application Publication
(10) Pub. No.: US 2005/0193085 A1
(43) Pub. Date: Sep. 1, 2005

(54) Information processing system, information processing method, and computer program

(76) Inventor: Takanori Shimizu, Kanagawa (JP)

Correspondence Address: William E. Vaughan;Bell, Boyd & Lloyd LLC, P.O. Box 1135, Chicago, IL, 60690, US

(21) Appl. No.: 11/054,212

(22) Filed: Feb. 8, 2005

(30) Foreign Application Priority Data
Feb. 26, 2004 (JP) P2004-050651

(51) Int. Cl. G06F 15/167

(52) U.S. Cl. 709/216; 709/214

(57) ABSTRACT

An information processing system, an information processing method and a computer program wherein two or more apparatuses connected to each other by a network are linked in operation with each other. An information processing system and method is provided wherein a storage space can be shared among information processing apparatus which operate cooperatively through a network. Each information processing apparatus includes one or more physical storage apparatus, and a physical storage space of each physical storage apparatus, that is, a physical segment address space, is mapped to a logical storage space, that is, a virtual address space such that execution of a process is performed on the physical address space. If an information processing apparatus is permitted to use an open area from a different information processing apparatus, then the information processing apparatus maps and uses the physical segment addresses of the open area to and together with the virtual segment address of the virtual address space of the self apparatus.

### CROSS REFERENCE TO RELATED APPLICATIONS

The present application claims priority to Japanese Patent Document No. P2004-050651 filed on Feb. 26, 2004, the disclosure of which is herein incorporated by reference.

### BACKGROUND OF THE INVENTION

The present invention relates to an information processing system, an information processing method and a computer program wherein two or more apparatus connected to each other by a network are linked in operation with each other and more particularly to an information processing system, an information processing method and a computer program wherein two or more information processing apparatus connected to each other by a network are linked in operation with each other.

More specifically, the present invention relates to an information processing system, an information processing method and a computer program wherein a plurality of apparatus connected to a network perform distributed processing through cooperative operation therebetween such that they operate as a virtually single apparatus, and more particularly to an information processing system, an information processing method and a computer program wherein a storage space is shared by a plurality of information processing apparatus which cooperate with each other through a network.

It is known to implement sharing of information resources, sharing of hardware resources and collaboration among a plurality of users by connecting a plurality of computers to each other by a network. A LAN (Local Area Network), a WAN (Wide Area Network), the Internet and so forth are known as connection media between a plurality of users.

Particularly recently, techniques of a computer and a network have been and are entering deeply into general homes. Various information apparatus in a home such as a personal computer and a PDA (Personal Digital Assistant), AV apparatus such as a television receiver and a video reproduction apparatus, various information appliances, CE (Consumer Electronics) apparatus and so forth are connected to each other by a home network. Further, such a home network as just mentioned is in most cases connected to an external wide area network beginning with the Internet through a router.

Although a utilization form that a plurality of AV apparatus are connected on a home network in this manner is supposed, the utilization form has a problem that sufficient cooperation is not established between a plurality of AV apparatus.

In order to solve such a problem as described above, investigation and development regarding a grid computing technique which achieves a high arithmetic operation performance through cooperative operation of several apparatus have been and are proceeding. Relating techniques are disclosed, for example, in Japanese Patent Laid-Open No. 2002-342165 (hereinafter referred to as Patent Document 1), Japanese Patent Laid-Open No. 2002-351850 (hereinafter referred to as Patent Document 2), Japanese Patent Laid-Open No. 2002-358289 (hereinafter referred to as Patent Document 3), Japanese Patent Laid-Open No. 2002-366533 (hereinafter referred to as Patent Document 4), and Japanese Patent Laid-Open No. 2002-366534 (hereinafter referred to Patent document 5).

According to the grid computing technique, a plurality of information processing apparatus on a network cooperatively operate to perform distributed processing such that they operate virtually as a single information processing apparatus to a user.

For example, where a plurality of information processing apparatus having a recording reservation function are connected to a network, cooperative operation for recording reservation can be implemented. In particular, where a plurality of information processing apparatus cooperate with each other in recording reservation operation through a home network, they operate virtually as a single recording apparatus on the network. Thus, the user can use a user interface of one of the apparatus to perform recording reservation using an arbitrary one of the apparatus connected to the network.

Further, such cooperation in recording reservation function allows simultaneous recording of different programs having reservation times which overlap with each other. Similarly, it is possible to cause reproduction operation of recorded contents to be performed through cooperation of a plurality of apparatus to achieve simultaneous or synchronous reproduction of the contents. Such cooperation in contents reproduction function allows reproduction of contents recorded by different apparatus to be performed simultaneously or synchronously. Thus, a concept of channel switching can be introduced into contents reproduction.

According to such a virtual single apparatus as described above, even where a request from a user cannot be met with a hardware resource or a processing capacity of a single apparatus, surplus processing capacities of other apparatus which cooperate with each other on a network can be utilized to meet the request of the user. Also a service which cannot be achieved actually with a single ordinary apparatus can be achieved by such a virtual single apparatus as described above.

On the other hand, such a virtual single information processing system as described above has a problem in that information processing apparatus which compose the system are various in hardware configuration, processing capacity and current processing load among them and surplus processing capacities of them are different among them.

Thus, with such a virtual single information processing system as described above, such a wasteful situation may possibly occur that, while a certain one of the information processing apparatus which cooperate with each other through the network does not have a surplus processing capacity and exhibits shortage in memory resource, another one of the information processing apparatus has a surplus processing capacity and involves a sufficient unused memory area in an operating system.

For example, a memory sharing system has been proposed in Japanese Patent Laid-Open No. Hei 8-95928 (hereinafter referred to as Patent Document 6) by which a flexible use of a memory between a plurality of computers connected to each other by a LAN circuit to achieve effective utilization of a memory resource and high speed operation in swapping processing.

In the memory sharing system, a memory management computer having a shared memory is provided on a LAN in advance and performs memory allocation in response to a memory allocation request from a memory requesting computer. In other words, the memory requesting computer and the memory management computer operate independently of each other except a procedure relating to the memory allocation request. Therefore, the memory sharing system is different from a grid computer wherein different information processing apparatus on a network cooperate with each other such that they act virtually as a single information processing apparatus.

Further, in the memory sharing system, the memory requesting computer side does not allocate the shared memory allocated to another computer to the memory space of the memory requesting computer itself, and therefore, accessing to the shared memory is nothing but a network operation through the LAN at all. In other words, the memory requesting computer side cannot perform accessing to the shared memory equivalently to accessing to the main memory of the memory requesting computer itself.

### SUMMARY OF THE INVENTION

The present invention relates to an information processing system, an information processing method and a computer program wherein two or more apparatus connected to each other by a network are linked in operation with each other and more particularly to an information processing system, an information processing method and a computer program wherein two or more information processing apparatus connected to each other by a network are linked in operation with each other.

More specifically, the present invention relates to an information processing system, an information processing method and a computer program wherein a plurality of apparatus connected to a network perform distributed processing through cooperative operation therebetween such that they operate as a virtually single apparatus, and more particularly to an information processing system, an information processing method and a computer program wherein a storage space is shared by a plurality of information processing apparatus which cooperate with each other through a network.

The present invention in an embodiment provides an information processing system, an information processing method and a computer program which are superior in that a plurality of apparatus connected to a network can operate virtually as a single apparatus through distributed processing by cooperative operation among them.

It is another embodiment of the present invention to provide an information processing system, an information processing method and a computer program which are superior in that a storage space can be shared among a plurality of information processing apparatus which operate cooperatively through a network.

According to an embodiment of the present invention, there is provided an information processing system, including a plurality of information processing apparatus connected to each other by a network in such a manner as to cooperate with each other to virtually form a single virtual information processing apparatus, wherein each information processing apparatus includes a physical storage apparatus, and at least one of the information processing apparatus being operable to form, on a physical storage space of the physical storage apparatus thereof, an open area whose use is permitted to the different information processing apparatus and permit use of the open area in response to a request for use of the open area from any of the different information processing apparatus.

It is to be noted here that the term “system” is used to represent a logical set apparatus composed of a plurality of apparatus or a plurality of modules for implementing predetermined functions, which may be included in the same housing or may be provided discretely.

The information processing system virtually operates as a single virtual information processing apparatus through cooperative operation of a plurality of information processing apparatus connected to each other by a network. At least one of the information processing apparatus which form the virtual information processing apparatus forms, on a physical storage space of a physical storage apparatus thereof, an open area whose use is permitted to the different information processing apparatus. The physical storage apparatus here includes a main memory and other local memories, an external storage apparatus such as a hard disk, and an I/O space to which inputting and outputting to and from different apparatus locally connected to the self apparatus. Thus, such information resources as mentioned above can be shared by the information processing apparatus which cooperate with each other.

Such sharing of information resources is implemented by a predetermined handshake process relating to a request and a permission response between an information processing apparatus which requests for an open area and another information processing apparatus which provides an open area. The handshake procedure may include a process for mutual authentication between such information processing apparatus and so forth.

According to another embodiment of the present invention, there is provided an information processing apparatus which operates as a component of a single virtual information processing apparatus formed through cooperation of the information processing apparatus with one or more different information processing apparatus connected thereto through a network, including a physical storage space, an open area formed on the physical space for permitting use thereof by the different information processing apparatus, and an open area use control section for permitting use of the open area in response to a request for use of the open area from any of the different information processing apparatus.

According to a further embodiment of the present invention, there is provided an information processing method for causing an information processing apparatus to operate as a component of a single virtual information processing apparatus formed through cooperation of the information processing apparatus with one or more different information processing apparatus connected thereto through a network, the information processing apparatus having a physical storage space on which an open area for permitting use thereof by the different information processing apparatus is formed, the information processing method including the steps of permitting use of the open area to any of the different information processing apparatus, allocating an open area address to a physical address of the open area whose use is to be permitted to any of the different information processing apparatus, converting, when an access request to the open area is received from any of the different information processing apparatus, the open area address of an object of the access request into a physical address, and returning data extracted from the physical address of the physical storage space as data on the open area address.

According to a still further embodiment of the present invention, there is provided an information processing method for causing an information processing apparatus to operate as a component of a single virtual information processing apparatus formed through cooperation of the information processing apparatus with one or more different information processing apparatus connected thereto through a network, any of the different information processing apparatus having an open area formed on a physical storage space thereof, the information processing method comprising the steps of issuing a request for use of the open area to the pertaining different information processing apparatus, allocating, in response to permission of the request for use, a logical address to an open area address whose use is permitted, converting, when a logical address of an object of an access request corresponds to the open area whose use is permitted from the pertaining different information processing apparatus, the logical address of the object of the access request into an open area address and issuing an access request to the pertaining different information processing apparatus, and converting data on the open area address returned from the pertaining different information processing apparatus into a logical address and returning the logical address to the source of the access request.

According to a yet further embodiment of the present invention, there is provided a computer program described in a computer-readable form for causing a computer system to execute a process for allowing an information processing apparatus to operate as a component of a single virtual information processing apparatus formed through cooperation of the information processing apparatus with one or more different information processing apparatus connected thereto through a network, the information processing apparatus having a physical storage space on which an open area for permitting use thereof by the different information processing apparatus is formed, the computer program including the steps of permitting use of the open area to any of the different information processing apparatus, allocating an open area address to a physical address of the open area whose use is to be permitted to any of the different information processing apparatus, converting, when an access request to the open area is received from any of the different information processing apparatus, the open area address of an object of the access request into a physical address, and returning data extracted from the physical address of the physical storage space as data on the open area address.

According to a yet further embodiment of the present invention, there is provided a computer program described in a computer-readable form for causing a computer system to execute a process for allowing an information processing apparatus to operate as a component of a single virtual information processing apparatus formed through cooperation of the information processing apparatus with one or more different information processing apparatus connected thereto through a network, any of the different information processing apparatus having an open area formed on a physical storage space thereof, the computer program including the steps of issuing a request for use of the open area to the pertaining different information processing apparatus, allocating, in response to permission of the request for use, a logical address to an open area address whose use is permitted, converting, when a logical address of an object of an access request corresponds to the open area whose use is permitted from the pertaining different information processing apparatus, the logical address of the object of the access request into an open area address and issuing an access request to the pertaining different information processing apparatus, and converting data on the open area address returned from the pertaining different information processing apparatus into a logical address and returning the logical address to the source of the access request.

The computer programs define computer programs described in a computer-readable form so that predetermined processes may be implemented on a computer system. In other words, where any of the computer programs is installed into a computer system, cooperative operation is exhibited on the computer system, and advantages similar to those provided by the information processing system of the present invention can be achieved.

In summary, with the information processing system, apparatus and methods and the computer programs, a plurality of apparatus connected to each other by a network can operate virtually as a single apparatus by performing distributed processing through cooperative operation thereof.

Further, with the information processing system, apparatus and methods and the computer programs, it is possible for information processing apparatus, which cooperate with each other through a network, to share a storage space there among.

For example, in an information processing system formed from a plurality of AV apparatus which cooperate with each other on a home network, sharing of information among the AV apparatus can be achieved. In particular, it is possible to share information retained by an AV apparatus to preserve the information, to change information of another AV apparatus, or to change information of many AV apparatus from a different server. Also it is possible to disclose information to another AV apparatus or to disclose the same information to many AV apparatus.

Additional features and advantages of the present invention are described in, and will be apparent from, the following Detailed Description of the Invention and the figures.

### BRIEF DESCRIPTION OF THE DRAWINGS

FIG. 1 is a block diagram showing a configuration of a network system to which the present invention is applied in an embodiment;

FIGS. 2A, 2B and 2C are views illustrating an accessing procedure from a sub processor to a main memory in the network system of FIG. 1;

FIG. 3 is a view showing an example of a configuration of a software cell;

FIG. 4 is a view illustrating a data area of a software cell where a DMA command is a status returning command;

FIG. 5 is a diagrammatic view showing a plurality of information processing apparatus in a manner wherein they operate as a virtual single information processing apparatus;

FIG. 6 is a diagrammatic view illustrating an example of a software configuration of an information processing controller;

FIG. 7 is a diagrammatic view showing four information processing apparatus in a manner wherein they operate as a virtual single information processing apparatus;

FIG. 8 is a diagrammatic view illustrating an example of distributed processing by the system shown in FIG. 7;

FIG. 9 is a diagrammatic view showing a particular example of information processing apparatus and a system;

FIG. 10 is a block diagram showing a hardware configuration of a hard disk recorder shown in FIG. 9;

FIG. 11 is a diagrammatic view showing a software configuration of the hard disk recorder shown in FIG. 9;

FIG. 12 is a block diagram showing a hardware configuration of a PDA shown in FIG. 9;

FIG. 13 is a diagrammatic view showing a software configuration of the PDA shown in FIG. 9;

FIG. 14 is a block diagram showing a hardware configuration of a portable CD player shown in FIG. 9;

FIG. 15 is a diagrammatic view showing a software configuration of the portable CD player shown in FIG. 9;

FIG. 16 is a schematic view showing a configuration of another network system to which the present invention is applied in an embodiment;

FIGS. 17 and 18 are diagrammatic views illustrating processes performed by an information processing apparatus for forming an open area;

FIG. 19 is a schematic view illustrating a manner wherein a server apparatus which manages various data including open data and non-open data retains open data in an open area;

FIG. 20 is a diagrammatic view illustrating a manner wherein information of that one of two set top boxes connected to a network and cooperating with each other which serves as a server is mapped in the other set top box which serves as a client;

FIG. 21 is a diagrammatic view illustrating a manner wherein a set top box permits two other set top boxes to use an open area thereof;

FIG. 22 is a diagrammatic view illustrating a manner wherein a set top box uses open areas of two different set top boxes whose use is permitted by the different set top boxes;

FIG. 23 is a flow chart illustrating a handshake procedure relating to a request and a permission response transmitted between an information processing apparatus which requests for use of an open area and another information processing apparatus which provides an open area;

FIG. 24 is a flow diagram illustrating an operation sequence for allocating an open area on a physical space of an information processing apparatus to a virtual memory space of a different information processing apparatus;

FIGS. 25A and 25B are views schematically showing configurations of mapping tables of the set top box STB(a) and STB(b), respectively;

FIG. 26 is a flow diagram illustrating an operation sequence for accessing to an open area of an information processing apparatus from a different information processing apparatus; and

FIG. 27 is a diagrammatic view illustrating a memory access procedure of an information processing apparatus.

### DETAILED DESCRIPTION OF THE PREFERRED EMBODIMENTS

The present invention relates to an information processing system, an information processing method and a computer program wherein two or more apparatus connected to each other by a network are linked in operation with each other and more particularly to an information processing system, an information processing method and a computer program wherein two or more information processing apparatus connected to each other by a network are linked in operation with each other.

More specifically, the present invention relates to an information processing system, an information processing method and a computer program wherein a plurality of apparatus connected to a network perform distributed processing through cooperative operation therebetween such that they operate as a virtually single apparatus, and more particularly to an information processing system, an information processing method and a computer program wherein a storage space is shared by a plurality of information processing apparatus which cooperate with each other through a network.

A. System Configuration

The present invention allows two or more information processing apparatus set at different places from each other to be linked in operation with each other through a home network to achieve simplified, easy and efficient reservation recording operation on the apparatus. In order to allow the apparatus on the home network to cooperate with each other, the present invention makes use of a grid computing technique for achieving a high arithmetic operation performance through cooperation of the apparatus.

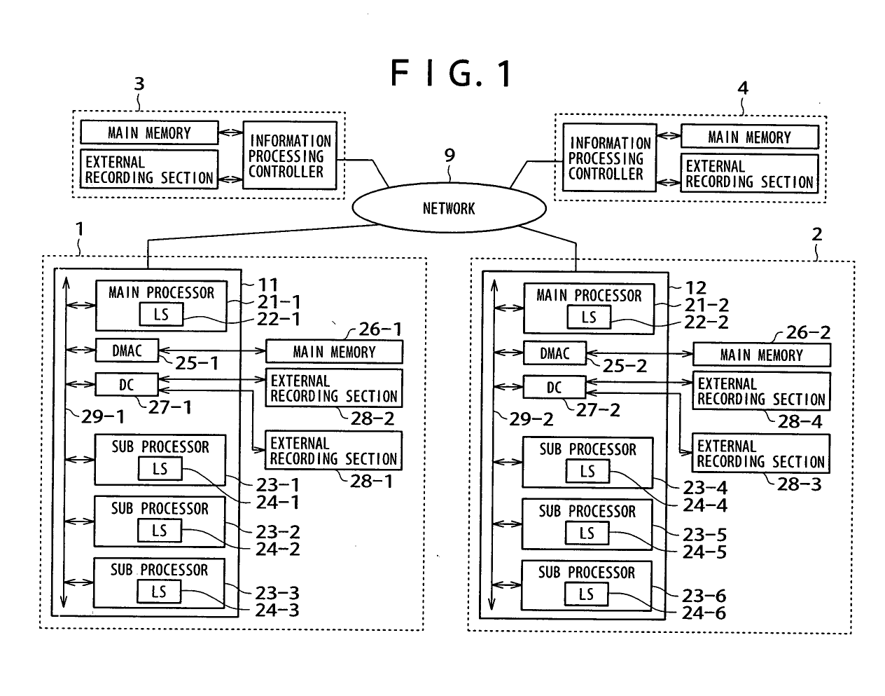

FIG. 1 schematically shows a configuration of a network system formed applying the grid computing.

The network may be formed from the Internet or some other wide area network and a private network such as a LAN (Local Area Network) or a home network which is connected to the wide area network through a gateway or the like. The home network may be physically formed from a standard network interface such as a 10 Base T interface, a 100 Base TX interface, or a Giga eather interface. Further, as a mechanism for discovering another apparatus on the home network, the Upnp (Universal Plug and Play) can be utilized. According to the Upnp, a definition file described in the XML (eXtended Markup Language) form is exchanged between different apparatus connected to each other by a network, and mutual authentication is performed through an addressing process, a discovery process, and a service request process. Such mutual authentication can be achieved also by broadcasting of a packet that describes prescribed apparatus information within the same segment.

A plurality of information processing apparatus are connected on the network. The information processing apparatus may include an AV apparatus such as a DVD recorder or an HD recorder, which incorporates a recording medium and has a reservation recording function, an AV apparatus for exclusive use for reproduction such as a compact disk player, which does not have a recording function, and other information processing apparatus. The information processing apparatus may further include a computer processing system such as a PDA or a personal computer. In the example shown in FIG. 1, a plurality of information processing apparatus 1, 2, 3, and 4 are connected to each other through a network 9.

A-1. Information Processing Apparatus and Information Processing Controller

The information processing apparatus 1, 2, 3, and 4 typically are various AV (Audio and Visual) apparatus and portable apparatus hereinafter described.

The information processing apparatus 1 includes an information processing controller 11 as a computer function section. The information processing controller 11 includes a main processor 21-1, sub processors 23-1, 23-2, and 23-3, a direct memory access controller (DMAC) 25-1, and a disk controller (DC) 27-1. The information processing controller 11 is preferably formed as a one-chip IC (Integrated Circuit).

The main processor 21-1 performs schedule management of program execution (data processing) by the sub processors 23-1, 23-2, and 23-3 and general management of the information processing controller 11 (information processing apparatus 1). However, the main processor 21-1 may be configured otherwise such that a program other than the program for performing the management operates in the main processor 21-1. In this instance, the main processor 21-1 functions also as a sub processor. The main processor 21-1 includes a local storage (LS) 22-1.

Although each information processing apparatus may include a single sub processor, preferably it includes a plurality of sub processors. In the example shown in FIG. 1, each of the information processing apparatus 1, 2, 3, and 4 includes a plurality sub processors. The sub processors 23-1, 23-2, and 23-3 execute programs parallelly and independently of each other to process data under the control of the main processor 21-1. Further, according to circumstances, a program in the main processor 21-1 can operate in cooperation with a program in any of the sub processors 23-1, 23-2, and 23-3. Also the sub processors 23-1, 23-2, and 23-3 include local storages 24-1, 24-2, and 24-3, respectively.

The direct memory access controller 25-1 accesses programs and data stored in a main memory 26-1 connected to the information processing controller 11 and formed from a DRAM (dynamic RAM) or the like without intervention of a processor. The disk controller 27-1 controls an accessing operation to external recording sections 28-1 and 28-2 connected to the information processing controller 11.

The external recording sections 28-1 and 28-2 may have a form of any of a fixed disk (hard disk) and a removable disk. As such a removable disk as just mentioned, various recording media such as an MO (magnetic disk), an optical disk such as a CD±RW or a DVD±RW, a memory disk, an SRAM (static RAM), and a ROM can be used. The disk controller 27-1 is an external recording section controller although it is called disk controller. The information processing controller 11 can be configured such that a plurality of external recording sections 28 are connected thereto as seen in FIG. 1.

The main processor 21-1, sub processors 23-1, 23-2, and 23-3, direct memory access controller 25-1, and disk controller 27-1 are connected to each other by a bus 29-1.

An identifier is allocated as an information processing apparatus ID to the information processing controller 11. The identifier can identify the information processing apparatus 1, which incorporates the information processing controller 11, uniquely over the entire network. Also to each of the main processor 21-1 and the sub processors 23-1, 23-2, and 23-3, an identifier with which it can be identified is allocated as a main processor ID or a sub processor ID similarly.

Also the other information processing apparatus 2, 3, and 4 are configured in a similar manner, and therefore, overlapping description of them is omitted herein to avoid redundancy. Here, it is to be noticed that those units of reference characters having the same parent number operate similarly unless otherwise specified even if they have different branch numbers. Thus, in the following description, where the branch number of reference characters is omitted, the units are same irrespective of the difference in branch number.

A-2. Accessing from Each Sub Processor to the Main Memory

As described hereinabove, although each of the sub processors 23 in one information processing controller executes a program independently to process data, if different sub processors perform reading out or writing at a time from or into same areas in the main memories 26, then mismatching of data may possibly occur. Therefore, accessing from the sub processors 23 to the main memories 26 is performed in accordance with the following procedure.

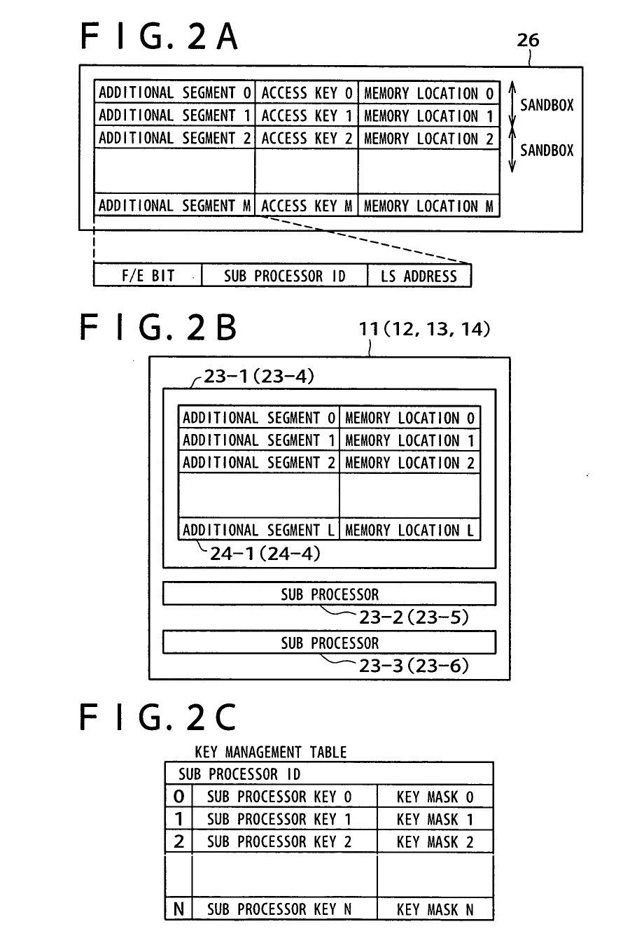

FIG. 2A illustrates locations in the main memory 26. As seen in FIG. 2A, the main memory 26 is formed from memory locations with which a plurality of addresses can be designated, and an additional segment for storing information indicative of a state of data is allocated to each memory location. The additional segment includes an F/E bit, a sub processor ID, and an LS address (Local Storage address). Also an access key hereinafter described is allocated to each memory location. The F/E bit is defined in the following manner.

The F/E bit=0 represents that the data in the corresponding memory location is data being read and processed by a sub processor 23 or invalid data which it not the latest data since the location is in a blank state and is disabled from being read out. Further, the F/E bit=0 indicates that data can be written into the corresponding memory location, and the F/E bit is set to 1 after writing into the memory location.

The F/E bit=1 represents that data of the corresponding memory location is not read out by any sub processor 23 and is the latest data not processed as yet. The data of the memory location can be read out. After the sub processor 23 read out the data, the F/E bit is set to 0. Further, the F/E bit=1 represents that the memory location is disabled from writing of data.

Further, in the state of the F/E bit=0 (readout disabled/writing enabled), it is possible to set a readout reservation with regard to the memory location. When readout reservation is to be performed with regard to a memory location with regard to which the F/E bit=0, a sub processor 23 writes the sub processor ID and the LS address of the sub processor 23 as readout reservation information into the additional segment of the memory location with regard to which the readout reservation is performed.

Thereafter, the sub processor 23 on the data writing side writes the data into the memory location having the readout reservation, and the F/E bit is set to F/E bit=1 (readout enabled/writing disabled). Then, the sub processor ID and the LS address written as the readout reservation information in the additional segment in advance are read out.

Where there is the necessity to process data at multiple stages using a plurality of sub processors, if readout/writing of data of each memory location are controlled in such a manner as described above, then immediately after data processed by a processor 23, which performs a process at a preceding stage, is written into a predetermined address on the main memory 26, another sub processor 23, which performs a process at a succeeding stage, can read out the pre-processed data.

FIG. 2B illustrates memory locations of a local storage 24 in each sub processor 23. Referring to FIG. 2B, also the local storage 24 in each sub processor 23 is formed from memory locations with which a plurality of addresses can be designated. An additional segment is allocated similarly to each of the memory locations. The additional segment includes a busy bit.

When the sub processor 23 is to read out data in the main memory 26 into a memory location of the local storage 24 thereof, it sets the corresponding busy bit to 1 to make reservation. Other data cannot be stored into any memory location with regard to which the busy bit is 1. After reading out of the memory location of the local storage 24, the busy bit is changed to 0 so that the memory location can be used for an arbitrary object later.

Referring back to FIG. 2A, the main memory 26 connected to each information processing controller includes a plurality of sandboxes for defining areas in the main memory 26. While the main memory 26 is formed from a plurality of memory locations, a sandbox is a set of such memory locations. Each sandbox is allocated for each sub processor 23 and can be used exclusively by the pertaining sub processor. In other words, each of the sub processors 23 can use a sandbox allocated thereto but cannot access data exceeding the area of the sandbox.

Further, in order to implement exclusive control of the main memory 26, such a key management table as shown in FIG. 2C is used. The key management table is stored in a comparatively high speed memory such as an SRAM in the information processing controller and is coordinated with a direct memory access controller 25. Each entry in the key management table includes a sub processor ID, a sub processor key, and a key mask.

The process when the sub processor 23 uses the main memory 26 is such as described below. First, the sub processor 23 outputs a readout or writing command to the direct memory access controller 25. This command includes the sub processor ID of the sub processor and an address of the main memory 26, which is a destination of the request for use.

Before the direct memory access controller 25 executes this command, it refers to the key management table to detect the sub processor key of the sub processor of the source of the request for use. Then, the direct memory access controller 25 compares the detected sub processor key of the source of the request for use with the access key allocated to the memory location shown in FIG. 2A in the main memory 26, which is the destination of the request for use. Then, only when the keys coincide with each other, the direct memory access controller 25 executes the command described above.

The key mask on the key management table shown in FIG. 2C can set, when an arbitrary bit thereof is set to the value 1, a corresponding bit of the sub processor key coordinated with the key mask to 0 or 1.

It is assumed that, for example, the sub processor key is 1010. Usually, the sub processor key enables accessing only to a sandbox having the access key of 1010. However, if the key mask coordinated with the sub processor key is set to 0001, then the coincidence determination between a sub processor key and an access key is masked only with regard to the digit in which the bit of the key mask is set to 1. Consequently, the sub processor key of 1010 enables accessing to a sandbox having the access key of 1010 or 1011.

The exclusive property of the sandboxes of the main memory 26 is implemented in such a manner as described above. In short, where there is the necessity for a plurality of sub processors in an information processing controller to process data at multiple stages, only a sub processor performing a process at a preceding stage and another sub processor performing a process at a succeeding stage are permitted to access a predetermined address of the main memory 26. Consequently, the data can be protected.

Such exclusive control of the memory can be used, for example, in the following manner. First, immediately after the information processing apparatus is started, the values of the key masks are all zero. It is assumed that a program in the main processor is executed and operates in a cooperating relationship with programs in the sub processors. When it is intended to store processing result data outputted from a first sub processor once into the main memory and then input the processing result data to a second sub processor, it is necessary that the pertaining main memory area can be accessed from the two sub processors. In such an instance, the program in the main processor changes the values of the key masks suitably to provide a main memory area, which can be accessed from the plurality of sub processors, to allow multi-stage processing by the sub-processors.

More particularly, when multi-stage processing is to be performed in the process of data from a different information processing apparatus→processing by the first sub processor→first main memory area→processing by the second sub processor→second main memory area, the second processor cannot access the first main memory area if the following settings are maintained:
Sub processor key of the first sub processor, 0100;
Access key of the first main memory area, 0100;
Sub processor key of the second sub processor, 0101;
Access key of the second main memory area, 0101.

Thus, if the key mask of the second sub processor is changed to 0001, then the second sub processor is permitted to access the first main memory area.

A-3. Production and Configuration of a Software Cell

In the network system of FIG. 1, a software cell is transmitted between the information processing apparatus 1, 2, 3, and 4 so that distributed processing may be performed by the information processing apparatus 1, 2, 3, and 4. In particular, the main processor 21 included in the information processing controller in a certain information processing apparatus produces a software cell including a command, a program, and data and transmits the software cell to another information processing apparatus through the network 9 to achieve distribution of processing.

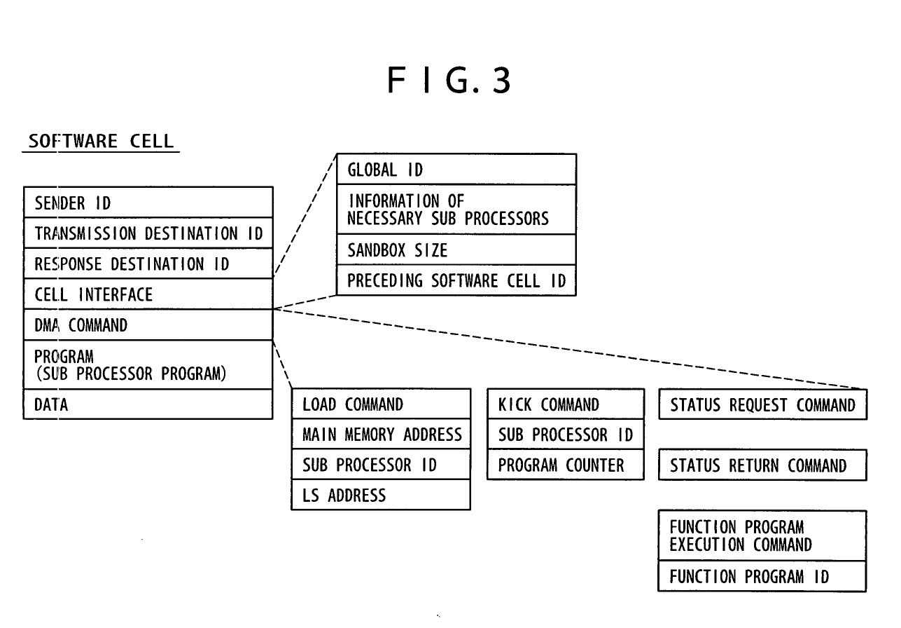

FIG. 3 shows an example of a configuration of a software cell. Referring to FIG. 3, the software cell shown includes a sender ID, a transmission destination ID, a response destination ID, a cell interface, a DMA command, a program, and data.

The sender ID includes a network address of an information processing apparatus of the sender of the software cell and the information processing apparatus ID of the information processing controller in the information processing apparatus. The sender ID includes identifiers (main processor ID and sub processor IDs) of the main processor 21 and the sub processors 23 included in the information processing controller in the information processing apparatus.

The sender ID and the response destination ID individually include the same information regarding an information processing apparatus of the transmission destination of the software cell and an information processing apparatus of the response destination of a result of execution of the software cell.

The cell interface is information necessary for utilization of the software cell and includes a global ID, information of necessary sub processors, a sandbox size, and a preceding software cell ID.

The global ID allows unique identification of the software cell through the entire network and is produced based on the sender ID and the date and hour of production or transmission of the software cell.

The information of necessary sub processors has set therein the number of sub processors necessary for execution of the software cell. The sandbox side has set therein the memory capacities in the main memory 26 and the local storages 24 of the sub processors 23 necessary for execution of the software cell.

The preceding software cell ID is an identifier of a preceding software cell among software cells of one group, which requires sequential execution such as streaming data.

An execution section of a software cell is formed from the DMA command, program, and data. The DMA command includes a series of DMA commands necessary to start the program, and the program includes sub processor programs to be executed by the sub processors 23. The data here is data to be processed by the program including the sub processor programs.

The DMA command further includes a load command, a kick command, a function program execution command, a status request command, and a status return command.

The load command is a command for loading information in the main memory 26 into the local storage 24 of a sub processor 23 and includes, in addition to the load command itself, a main memory address, a sub processor ID, and an LS (Local Storage) address. The main memory address indicates an address of a predetermined area in the main memory 26, which is a load source of the information. The sub process ID and the LS address indicate the identifier and the address of the local storage 24 of the sub processor 23 of a load destination of the information.

The kick command is a command for starting execution of a program and includes, in addition to the kick command, a sub processor ID and a program counter. The sub processor ID identifies a sub processor 23 of a kicking object, and the program counter provides an address for the program counter for execution of the program.

The function program execution command is a command (hereinafter described) used for a certain information processing apparatus to request another information processing apparatus for execution of a function program. The information processing controller in the information processing apparatus, which receives the function program execution command, identifies a function program to be started from a function program ID (hereinafter described).

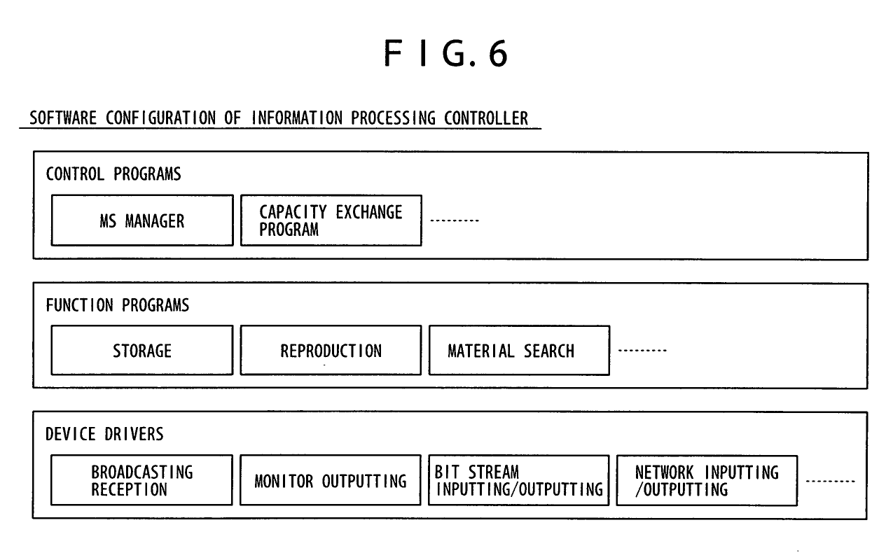

The status request command is a command for requesting for transmission of apparatus information regarding a current operation state (situation) of an information processing apparatus indicated by the transmission destination ID to an information processing apparatus indicated by the response destination ID. While the function program is hereinafter described, it is a program categorized into a function program in FIG. 6, which illustrates a configuration of software stored in the main memory 26. The function program is loaded into the main memory 26 and executed by the main processor 21.

The status return command is a command used for an information processing apparatus, which receives the status request command, to issue a response of apparatus information of the information processing apparatus itself to an information processing apparatus indicated by the response destination ID included in the status request command.

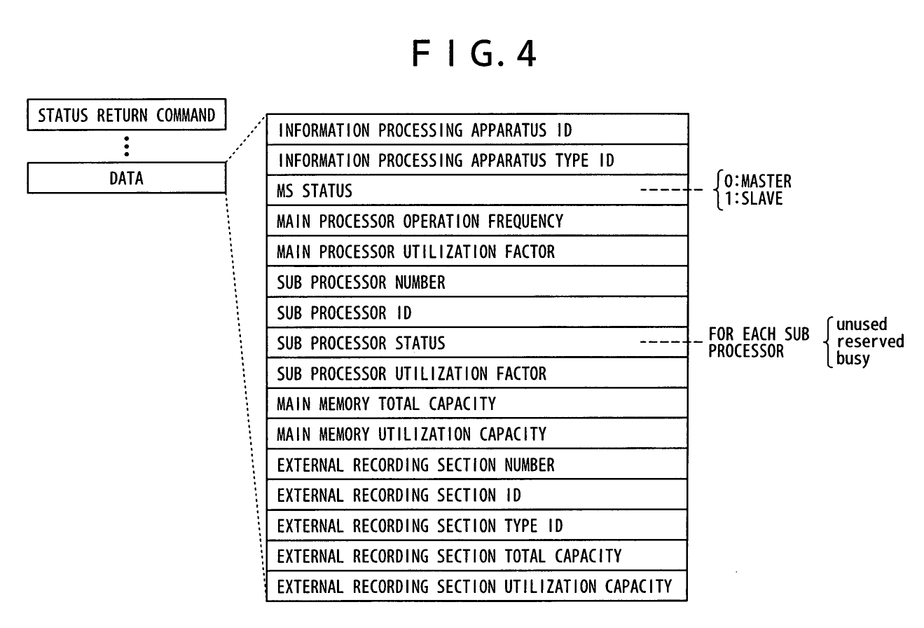

FIG. 4 illustrates a structure of the data area of a software cell where the DMA command is the status return command.

Referring to FIG. 4, the information processing apparatus ID is an identifier for identifying an information processing apparatus, which includes an information processing controller, and represents the ID of an information processing apparatus that transmits the status return command. The information processing apparatus ID is produced, when the power supply is made available, based on the date and hour when the power supply is made available, the network address of the information processing apparatus, the number of sub processors 23 included in the information processing controller in the information processing apparatus, and so forth by the main processor 21 included in the information processing controller in the information processing apparatus.

The information processing apparatus type ID includes a value representative of a characteristic of the information processing apparatus. The characteristic of the information processing apparatus here is, for example, a hard disk recorder (hereinafter described), a PDA (Personal Digital Assistant), a portable CD (Compact Disc) player, or the like. The information processing apparatus type ID may be of the type representing a function that the information processing apparatus has such as image and sound recording or image and sound reproduction. The value representative of a characteristic or a function of an information processing apparatus is determined in advance. If the information processing apparatus type ID is recalled, then a characteristic or a function of the information processing apparatus can be grasped.

The MS (Master/Slave) status represents which one of a master apparatus and a slave apparatus operates the information processing apparatus as hereinafter described. Where the MS status is set to 0, this represents that the information processing apparatus should operate as a master apparatus, but where the MS status is set to 1, this represents that the information processing apparatus should operate as a slave apparatus.

The main processor operation frequency represents an operation frequency of the main processor 21 in the information processing controller. The main processor utilization factor represents the utilization factor in the main processor 21 regarding all programs, which are operating in the main processor 21 at present. The main processor utilization factor is a value representing the ratio of the processing capacity being currently used to the overall processing capacity of the object main processor and is calculated, for example, in a unit of MIPS, which is a unit for evaluation of the processor processing capacity, or based on the processor utilization time per unit time. This similarly applies also to a sub processor utilization factor hereinafter described.

The sub processor number represents the number of sub processors 23 provided in the information processing controller. The sub processor ID represents an identifier for identification of a sub processor 23 in the information processing controller.

The sub processor status represents a status of the sub processor 23 and may be one of an unused status, a reserved status, a busy status, and so forth. The unused status indicates that the sub processor is not used at present and is not reserved for use either. The reserved status indicates that the sub processor is not used but is reserved for use. The busy status indicates that the sub processor is currently used.

The sub processor utilization factor represents the utilization factor in the sub processor regarding a program being executed by the sub processor or being reserved for execution in the sub processor. In other words, the sub processor utilization factor indicates the utilization factor at present where the sub processor status is busy, but indicates an estimated utilization factor with which the sub processor is planned to be used later where the sub processor status is reserved.

One set of the sub processor ID, sub processor status, and sub processor utilization factor is set for one sub processor 23. Consequently, a number of sets corresponding to the number of sub processors 23 in one information processing controller are set.

The main memory total capacity and the main memory utilization capacity represent the total capacity and the capacity being currently used of the main memory 26 connected to the information processing controller, respectively.

The external recording section number represents the number of external recording sections 28 connected to the information processing controller. The external recording section ID is information for unique identification of each of the external recording sections 28 connected to the information processing controller. The external recording section type ID represents the type of each of the external recording sections 28 (for example, a hard disk, a CD±RW, a DVD±RW, a memory disk, an SRAM, a ROM, or the like).

The external recording section total capacity and the external recording section utilization capacity represent the total capacity and the currently used capacity of an external recording section 28 identified with the external recording section ID, respectively.

A set of the external recording section ID, external recording section type ID, external recording section total capacity, and external recording section utilization capacity is set for one external recording section 28. Consequently, a number of sets corresponding to the number of external recording sections 28 connected to the information processing controller are set. In particular, where a plurality of external recording sections are connected to an information processing controller, different external recording section IDs are applied individually to the external recording sections, and also the external recording section type IDs, external recording section total capacities, and external recording section utilization capacities are managed separately from each other.

A-4. Execution of a Software Cell

The main processor 21 included in the information processing controller in a certain information processing apparatus produces a software cell having such a configuration as described above and transmits a different information processing apparatus and the information processing controller in the different information processing apparatus through the network 9. The information processing apparatus of the sender, the information processing apparatus of the transmission destination, the information processing apparatus of the response destination, and the information processing controllers in the apparatus mentioned are individually identified with the sender ID, transmission destination ID, and response destination ID described hereinabove, respectively.

The main processor 21 included in the information processing controller in the information processing apparatus receiving the software cell stores the software cell into the main memory 26. Further, the main processor 21 of the transmission destination reads out the software cell and processes the DMA command included in the software cell.

In particular, the main processor 21 of the transmission destination first executes the load command. Consequently, the information is loaded from the main address indicated by the load command into a predetermined area of the local storage 24 in a sub processor specified by the sub processor ID and the LS address included in the load command. The information loaded here is a sub processor program or data or some other indicated data included in the received software cell.

Then, the main processor 21 outputs the kick command to a sub processor indicated by the sub processor ID included in the kick command together with a program counter included in the kick command similarly.

The indicated sub processor executes the sub processor program in accordance with the kick command and the program counter. Then, the sub processor stores a result of the execution into the main memory 26, and then notifies the main processor 21 of completion of the execution.

It is to be noted that the processor executing the software cell in the information processing controller in the information processing apparatus of the transmission destination is not limited to a sub processor 23, but it is possible to designate the main processor 21 so as to execute a main memory program such as a function program included in the software cell.

In this instance, the information processing apparatus of the sender transmits, to the information processing apparatus of the transmission destination, a software cell whose DMA command is the load command. The software cell includes a main memory program and data to be processed by the main memory program in place of the sub processor program. The main memory program and the data to be processed by the main memory program are stored into the main memory 26.

Then, the information processing apparatus of the sender transmits, to the information processing apparatus of the transmission destination, a software cell whose DMA command is the kick command or the function program execution command. The software cell includes the main processor ID and main memory address of the information processing controller in the information processing apparatus of the transmission destination, an identifier for identification of the main memory program such as a function program ID hereinafter described, and a program counter. Thus, the main processor 21 may execute the main memory program.

As described above, in the network system according to the present embodiment, an information processing apparatus of the sender transmits a sub processor program or a main memory program in the form of a software cell to an information processing apparatus of the transmission destination. Further, the information processing apparatus of the sender causes the information processing controller in the information processing apparatus of the transmission destination to load the sub processor program into a sub processor 23. Consequently, the information processing apparatus of the sender can cause the information processing apparatus of the transmission destination to execute the sub processor program or the main memory program.

Where the program included in the received software cell is a sub processor program, the information processing controller in the information processing apparatus of the transmission destination loads the sub processor program into a designated sub processor. Thus, the information processing controller causes the sub processor to execute the sub processor program or the main memory program included in the software cell.

Accordingly, even if the user does not operate the information processing apparatus of the transmission destination, the sub processor program or the main memory program can be executed automatically by the information processing controller in the information processing apparatus of the transmission destination.

In this manner, any information processing apparatus can acquire, where the information processing controller thereof does not include a sub processor program or a main memory program such as a function program, such programs from anther information processing apparatus connected thereto by the network. Further, different sub processors can transfer data therebetween in accordance with the DMA system and such sandboxes as described hereinabove are used. In such a case, even where it is necessary to process data at multiple states within one information processing controller, the processing can be executed at a high speed and with a high degree of security.

A-5. Distributed Processing of the Network System

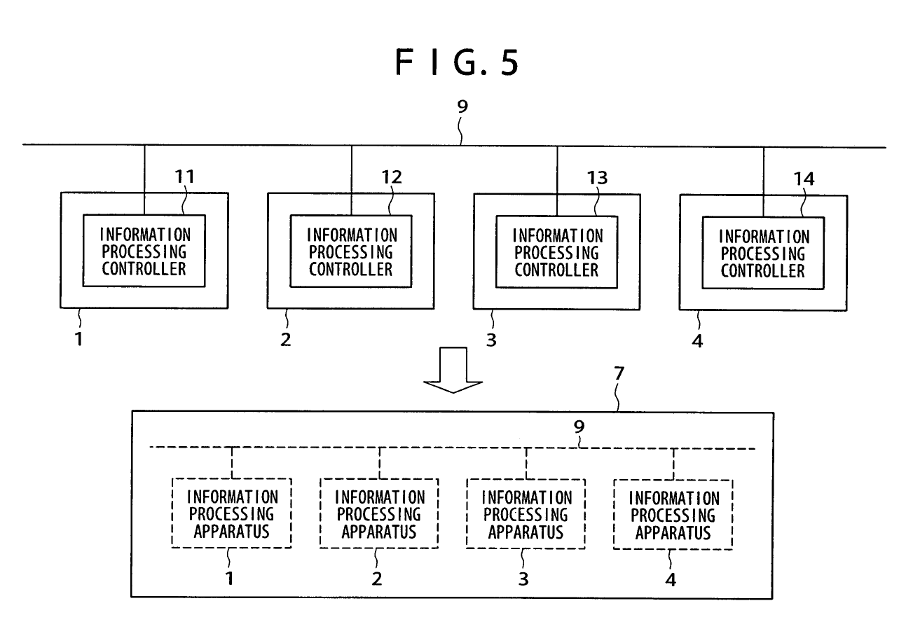

FIG. 5 illustrates a manner wherein a plurality of information processing apparatus operate as a virtual single information processing apparatus. As a result of the distributed processing through use of a software cell, the plural information processing apparatus 1, 2, 3, and 4 connected to the network 9 as seen at the upper stage in FIG. 5 operate as a virtual single information processing apparatus 7 as seen at the lower stage in FIG. 5. However, in order to implement such virtual operation as just described, processes described below must be executed.

A-6. Software Configuration of the System and Loading of a Program

FIG. 6 illustrates a configuration of software to be stored by the main memories 26 of the individual information processing controllers. Referring to FIG. 6, the pieces of software (programs) are recorded in an external recording section 28 connected to the information processing controller before the power supply is made available to the information processing apparatus. The programs are classified, depending upon the function or characteristic thereof, into control programs, function programs, and device drivers.

The control programs are provided commonly in the information processing controllers and executed by the main processor 21 in each of the information processing controllers. The control programs include an MS (Master/Slave) manager and a capacity exchange program hereinafter described.

The main processors 21 execute the function programs, and for each information processing apparatus, such function programs as a recording program, a reproduction program, a material search program, and so forth are provided for the information processing controller.

The device drivers are provided for inputting and outputting (transmission and reception) of each information processing controller (information processing apparatus), and such devices as those for broadcast reception, monitor outputting, bit stream inputting/outputting, network inputting/outputting, and so forth, which are suitable for each of the information processing apparatus, are provided for the information processing controller.

When the power supply is made available to an information processing apparatus in a state wherein the information processing apparatus is physically connected to the network 9 by connection of a cable or the like and consequently the information processing apparatus is connected to the network 9 also electrically and functionally, the main processor 21 of the information processing controller of the information processing apparatus loads the programs belonging to the control programs and the programs belonging to the device drivers into the main memory 26.

As a loading procedure of the programs, the main processor 21 first controls the disk controller 27 to execute a reading out instruction to read out the programs from the external recording section 28 and then controls the direct memory access controller 25 to execute a writing instruction to write the programs into the main memory 26.

The programs belonging to the function programs may be handled such that only a necessary one of the programs is loaded when necessary or otherwise such that all of them are loaded immediately after the main power supply is made available similarly to the programs belonging to the other categories.

The programs belonging to the function programs need not necessarily be recorded in the external recording sections 28 of all of the information processing apparatus connected to the network. If they are recorded in an external recording section 28 of any one of the information processing apparatus, they can be loaded into the other information processing apparatus by the method described hereinabove. As a result, the function programs can be executed by the virtual single information processing apparatus 7 as shown at the lower stage of FIG. 5.

A function program processed by the main processor 21 sometimes operates cooperatively with a sub processor program processed by a sub processor 23 as described hereinabove. Therefore, a sub processor program may exist to operate cooperatively with a function program, which makes an object when the main processor 21 reads out the function program from an external recording section 28 and writes the function program into the main memory 26. In that case, also, the sub processor program is written together with the function program into the same main memory 26. In this instance, the number of sub processor programs, which operate cooperatively, may be only one or a plural number. Where the number is a plural number, all of the sub processor programs, which operate cooperatively, are written into the main memory 26. The sub processor program or programs written in the main memory 26 are thereafter written into the local storage 24 in the sub processor 23 and operate cooperatively with the function program processed by the main processor 21.

Further, a sub processor program ID is allocated to each of the sub processor programs so that each of the sub processor programs can be identified uniquely. The sub processor program ID to be allocated may be an identifier having some relationship with the function program ID of the function program, which is the other party of the cooperative operation such as, for example, an identifier formed from the function program ID as a parent number and a branch number added to the tail end of the parent number, or an identifier having no relationship with the function program ID of the function program, which is the other party of the cooperative operation. Anyway, where a function program and a sub processor program should operate cooperatively with each other, it is necessary for each of them to mutually retain the program ID of the identifier of the other party in the program itself. Also where a function program should operate cooperatively with a plurality of sub processor programs, it is necessary for the function program to retain the sub processor program IDs of all of the sub processor programs.

As described hereinabove in connection with the software cell shown in FIG. 3, an identifier, which can be identified uniquely, is allocated as a function program ID to each of the function programs. The function program ID is determined from the date and hour of production, the information processing apparatus ID, and so forth at a stage of production of the function program.

The main processor 21 secures, in the main memory 26, an area for storing apparatus information (information relating to an operation state) of the information processing apparatus in which the main processor 21 operates, and records the information as an apparatus information table of the information processing apparatus itself. The apparatus information here is information of the information processing apparatus ID and so forth in the data area of the status return command illustrated in FIG. 4.

A-7. Determination of the Master/Slave in the System

In the network system described above, when the main power supply to a certain information processing apparatus is made available, the main processor 21 of the information processing controller of the information processing apparatus loads a master/slave manager (hereinafter referred to as MS manager) into the main memory 26 and executes the master/slave manager.

After the MS manager detects that the information processing apparatus in which the MS manager operates is connected to the network 9, it confirms presence of the other information processing apparatus connected to the same network 9. The “connection” or “presence” here represents that the information processing apparatus is connected to the network 9 not only physically but also electrically and functionally.

The information processing apparatus in which the MS manager itself operates is hereinafter referred to as self apparatus, and any other information processing apparatus is referred to as different apparatus. Also the term pertaining apparatus represents the pertaining information processing apparatus.

A method by which the MS manager confirms presence of a different information processing apparatus connected to the same network 9 is described in the following.

The MS manager produces a software cell that designates the status request command as the DMA command and designates the pertaining information processing apparatus as the sender ID and the response destination ID but does not specify the transmission destination ID. Then, the MS manager transmits the software cell to the network to which the pertaining information processing apparatus is connected, and sets a timer for network connection confirmation. The timeout time of the timer is, for example, 10 minutes.

If a different information processing apparatus is connected to the network system, then the different apparatus receives the software cell of the status request command and transmits a software cell whose DMA command is the status return command and which includes apparatus information of the self apparatus (different apparatus) as the data to an information processing apparatus which is specified by the response destination ID of the received software cell and has issued the status request command. The software cell of the status return command at least includes information for specifying the different apparatus (information processing apparatus ID, information regarding the main processor, information regarding a sub processor, or the line) and the MS status of the different apparatus.

The MS manager of the information processing apparatus, which has issued the status request command, supervises reception of a software cell of the status return command transmitted from the different apparatus on the network until timeout occurs with the timer for network connection confirmation. As a result, if the status return command representative of the MS status=0 (master apparatus) is received, then the MS status in the apparatus information table of the self apparatus is set to 1. Consequently, the pertaining apparatus becomes a slave apparatus.

On the other hand, if no status return command is received within the time until timeout occurs with the timer for network connection confirmation, or if the status return command representative of the MS status=0 (master apparatus) is not received, then the MS status in the apparatus information table of the self apparatus is set to 0. Consequently, the pertaining apparatus becomes a master apparatus.

In short, if a new information processing apparatus is connected to the network 9 in a state wherein no apparatus is connected to the network 9 or in another state wherein a master apparatus does not exist on the network 9, then the pertaining apparatus is automatically set as a master apparatus. On the other hand, if a new information processing apparatus is connected to the network 9 in a further state wherein a master apparatus exists already on the network 9, then the pertaining apparatus is automatically set as a slave apparatus.

In any of the master apparatus and slave apparatus, the MS manager periodically transmits the status request command to the different apparatus on the network 9 to inquire about the status information to supervise the situation of the different apparatus. As a result, when the connection state of the network 9 undergoes a variation such as when the main power supply to an information processing apparatus connected to the network 9 is cut or an information processing apparatus is disconnected from the network 9 and consequently the status return command is not returned from the particular different apparatus within a predetermined period of time set for the discrimination in advance, the information is conveyed to a capacity exchange program hereinafter described.

A-8. Acquisition of Apparatus Information by the Master Apparatus and a Slave Apparatus

If the main processor 21 receives, from the MS manager, a notification of an inquiry about a different information processing apparatus connected to the network 9 and completion of setting of the MS status of the self apparatus, then it executes a capacity exchange program.

The capacity exchange program acquires, if the self apparatus is a master apparatus, apparatus information of all different information processing apparatus connected to the network 9, that is, apparatus information of all slave apparatus.

The acquisition of apparatus information of a different apparatus can be performed such that the DMA command produces and transmits a software cell of the status request command to the different apparatus and then receives a software cell whose DMA command is the status return command and includes apparatus information of the different apparatus as the data from the different apparatus.

The capacity exchange program secures an area for storing apparatus information of all different apparatus (all slave apparatus) connected to the network 9 in the main memory 26 of the self apparatus and stores the information as apparatus information tables of the different apparatus (slave apparatus) similarly to the apparatus information table of the self apparatus as the master apparatus. In other words, the apparatus information of all of the information processing apparatus connected to the network 9 including the self apparatus is stored as apparatus information tables in the main memory 26 of the master apparatus.

On the other hand, if the self apparatus of the capacity exchange program is a slave apparatus, then the capacity exchange program acquires the apparatus information of all of the different apparatus connected to the network 9, that is, the apparatus information of the master apparatus and all of the slave apparatus other than the self apparatus, and records the information processing apparatus IDs and the MS statuses included in the apparatus information into the main memory 26 of the self apparatus. In other words, in the main memory 26 of each slave apparatus, the apparatus information of the self apparatus is recorded as an apparatus information table, and the information processing apparatus IDs and the MS statuses of all of the master apparatus and the slave apparatus connected to the network 9 other than the self apparatus are recorded as different apparatus information tables.

Further, in any of the master apparatus and the slave apparatus, when the capacity exchange program receives a notification that an information processing apparatus is newly connected to the network 9 from the MS manager as described above, it acquires apparatus information of the information processing apparatus and registers the apparatus information into the main memory 26 as described hereinabove.

It is to be noted that the MS manager and the capacity exchange program may be executed not by the main processor 21 but by any sub processor 23. Further, the MS manager and the capacity exchange program preferably are resident programs that operate normally while the main power supply to the information processing apparatus is available.

A-9. When an Information Processing Apparatus is Disconnected from the Network

In any of the master apparatus and the slave apparatus, if the capacity exchange program is notified from the MS manager that the main power supply to an information processing apparatus connected to the network 9 is disconnected or an information processing apparatus is disconnected from the network 9, it deletes the apparatus information table of the information processing apparatus from the main memory 26 of the self apparatus.

Further, if the information processing apparatus disconnected from the network 9 is the master apparatus, then another master apparatus is determined newly by the following method.

For example, each of those information processing apparatus that are not disconnected from the network 9 replaces the information processing apparatus IDs of the self apparatus and the different apparatus into numerical values and compares the information processing apparatus ID of the self apparatus with the information processing apparatus IDs of the different apparatus. If the information processing apparatus ID of the self apparatus exhibits the lowest value among the information processing apparatus that are not disconnected from the network 9, then the slave apparatus changes itself to the master apparatus and sets the MS status to zero. Then, it operates as the master apparatus and acquires and records the apparatus information of all of the different apparatus (slave apparatus) connected to the network 9 into the main memory 26 as described hereinabove.

A-10. Distributed Processing Based on Apparatus Information

In order to allow a plurality of information processing apparatus 1, 2, 3, and 4 connected to the network 9 to operate as a virtual single information processing apparatus 7 as shown at the lower stage of FIG. 5, it is necessary for the master apparatus to grasp an operation of a user and operation states of the slave apparatus.

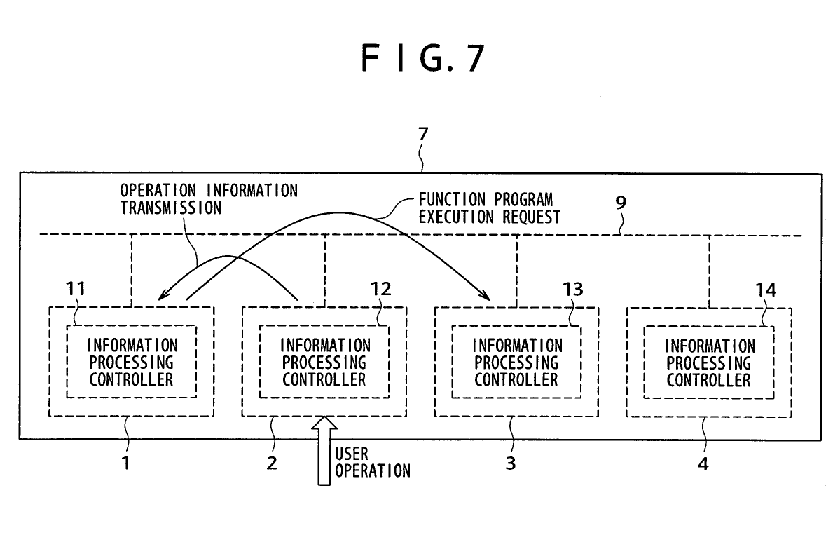

FIG. 7 shows four information processing apparatus in a state wherein they operate as a virtual single information processing apparatus 7. In the example shown, the information processing apparatus 1 acts as the master apparatus while the information processing apparatus 2, 3, and 4 act as slave apparatus A, B, and C, respectively.

When a user operates any of the information processing apparatus connected to the network 9, if the object of the operation is the master apparatus 1, then the operation information then is grasped directly by the master apparatus 1. On the other hand, if the object of the operation is a slave apparatus, then the operation information then is transmitted from the operated slave apparatus to the master apparatus 1. In other words, irrespective of whether the object of operation of the user is the master apparatus 1 or one of the slave apparatus, the master apparatus 1 always grasps the operation information. Transmission of the operation information is performed, for example, using a software cell whose DMA command is the operation information transmission command.

Then, the main processor 21-1 included in the information processing controller 11 in the master apparatus 1 selects a function program to be executed in accordance with the operation information. In this instance, if necessary, the main processor 21-1 included in the information processing controller 11 in the master apparatus 1 loads the function program from the external recording sections 28-1 and 28-2 of the self apparatus into the main memory 26-1 using the method described hereinabove. However, the function program may otherwise be transmitted from a different information processing apparatus (slave apparatus) to the master apparatus 1.

The function program defines required specifications regarding apparatus such as an information processing apparatus type ID, a processing capacity of the main processor or a sub processor, a main memory utilization capacity, and conditions relating to an external recording section (refer to FIG. 4).

The main processor 21-1 included in the information processing controller 11 in the master apparatus 1 reads out such requested specifications required by the individual function programs. Further, the main processor 21-1 refers to the apparatus information tables recorded in the main memory 26-1 by the capacity exchange program in advance to read out the apparatus information of the individual information processing apparatus. The apparatus information here signifies the items of information including the item of the information processing apparatus ID and the succeeding items illustrated in FIG. 4 and is information relating to the main processor, sub processors, main memory, and external recording sections.

The main processor 21-1 included in the information processing controller 11 in the master apparatus 1 successively compares the apparatus information of the information processing apparatus connected to the network 9 with the required specifications necessary for execution of the function program.

For example, if the function program requires a recording function, then the main processor 21-1 included in the information processing controller 11 in the information processing apparatus 1 specifies and extracts only those information processing apparatus, which have a recording function, based on the information processing apparatus type IDs. Further, the main processor 21-1 specifies that one of the slave apparatus that can assure the processing capacity of the main processor or a sub processor to execute the processing program, the main memory utilization capacity, and conditions regarding an external recording section as an execution request candidate apparatus. Here, if a plurality of execution request candidate apparatus are specified, then one of the execution request candidate apparatus is specified and selected.

After a slave apparatus to which an execution request is to be issued is specified, the main processor 21-1 included in the information processing controller 11 in the master apparatus 1 updates the apparatus information table with regard to the specified slave apparatus recorded in the main memory 26-1 included in the information processing controller 11 in the self apparatus.

Further, the main processor 21-1 included in the information processing controller 11 in the information processing apparatus 1 produces a software cell, which includes the load command and the kick command as the DMA commands, and sets information of a necessary sub processor and the sandbox size (refer to FIG. 3) regarding the function program to the cell interface of the software cell. Then, the main processor 21-1 transmits the resulting software cell to the slave apparatus, which is requested to execute the function program.

The slave apparatus requested to execute the function program executes the function program and updates the apparatus information table of the self apparatus. In this instance, if necessary, the main processor 21 included in the information processing controller in the slave apparatus loads the function program and a sub processor program or programs, which should cooperate with the function program, from an external recording section 28 of the self apparatus into the main memory 26 using the method described hereinabove.

The system may be configured as follows. If the necessary function program or a sub processor program, which should cooperate with the function program, is not recorded in any of the external recording sections 28 of the slave apparatus requested to execute the function program, then a different information processing apparatus transmits the function program or sub processor program to the slave apparatus requested to execute the function program.

The sub processor program may otherwise be executed by a different information processing apparatus making use of the load command or kick command described hereinabove.

After the execution of the function program comes to an end, the main processor 21 included in the information processing controller in the slave apparatus having executed the function program transmits an execution end notification to the main processor 21-1 included in the information processing controller in the slave apparatus, and updates the apparatus information table of the self apparatus. The main processor 21-1 included in the information processing controller 11 in the master apparatus 1 receives the end notification and updates the apparatus information table of the slave apparatus having executed the function program.

The main processor 21-1 included in the information processing controller 111 in the master apparatus 1 may possibly select the self apparatus as an information processing apparatus, which can execute the function program, from a result of the reference to the apparatus information tables of the self apparatus and the different apparatus. In this instance, the master apparatus 1 executes the function program.

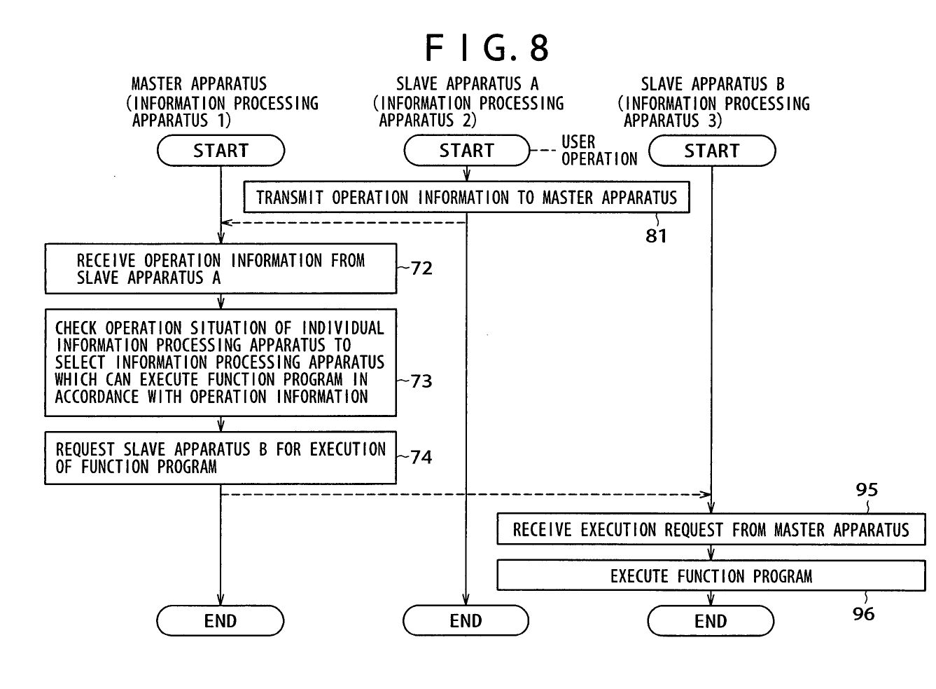

Distributed processing where a user operates, in the example illustrated in FIG. 7, the slave apparatus A (information processing apparatus 2) and the different slave apparatus B (information processing apparatus 3) executes a function program in response to the operation is described with reference to FIG. 8.

In the example illustrated in FIG. 8, when the user operates the slave apparatus A, distributed processing of the entire network system including the slave apparatus A is started, and the slave apparatus A first transmits operation information then to the master apparatus 1 (step 81).

The master apparatus 1 receives the operation information (step 72) and checks the operation states of the information processing apparatus from the apparatus information tables of the self apparatus and the different apparatus recorded in the main memory 26-1 of the self apparatus. Thus, the master apparatus selects an information processing apparatus that can execute a function program corresponding to the received operation information (step 73). In the example illustrated in FIG. 8, it is illustrated that the slave apparatus B is selected.

Then, the master apparatus 1 issues a request for execution of the function program to the selected slave apparatus B (step 74).

The slave apparatus B receives the execution request (step 95) and executes the function program whose execution is requested (step 96).

In this manner, if a user operates only one of the information processing apparatus, then it can cause the plural information processing apparatus 1, 2, 3, and 4 to operate as a virtual single information processing apparatus 7 without operating any other one of the information processing apparatus.

A-11. Particular Examples of the Information Processing Apparatus and the System

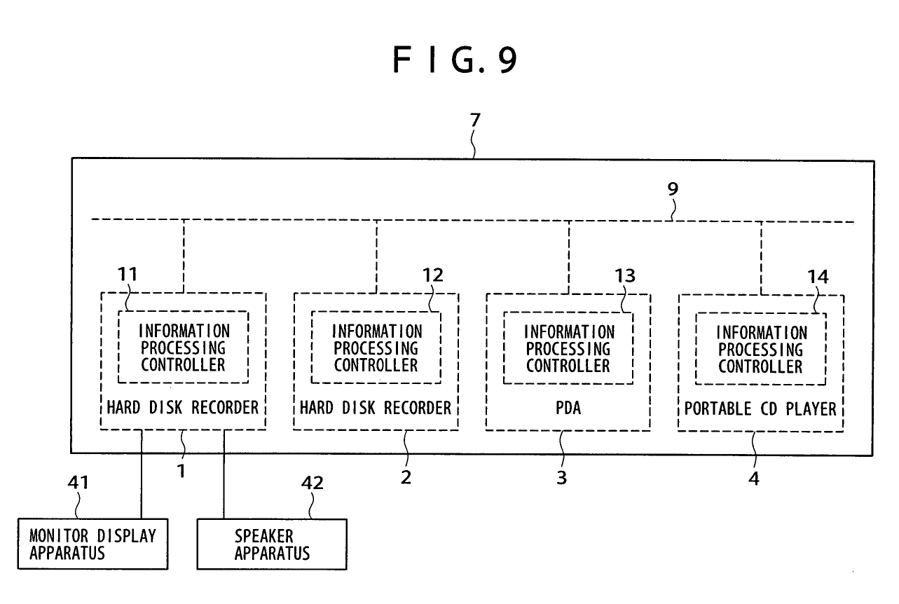

Each of the information processing apparatus 1, 2, 3 and 4 connected to each other through the network 9 may basically have any configuration only if information processing is performed by such an information processing controller 11, 12, 13 or 14 as described hereinabove. FIG. 9 shows an example of a configuration of the information processing apparatus.

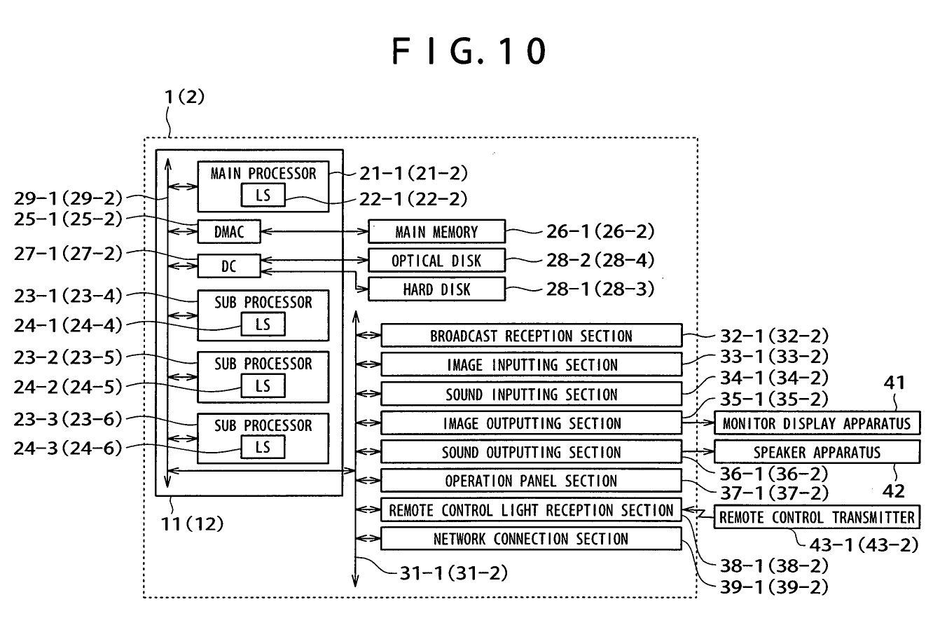

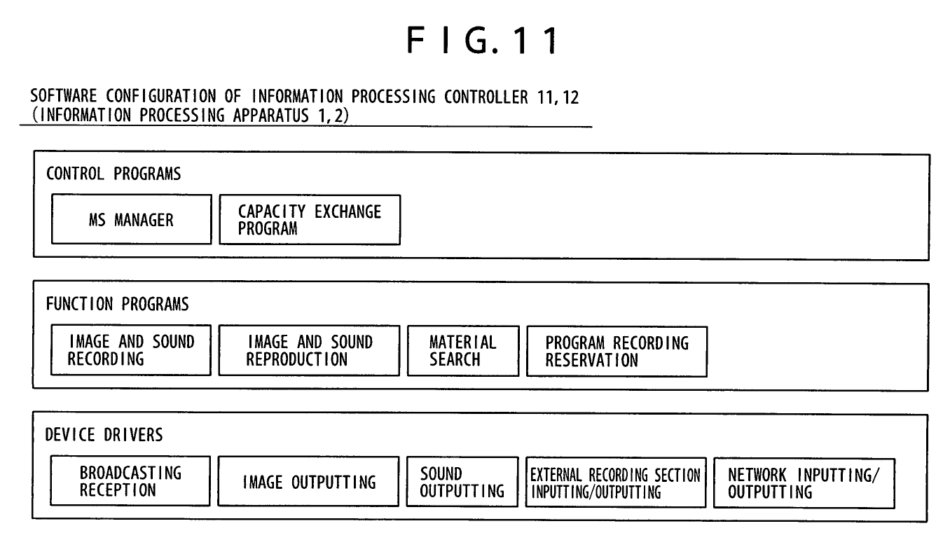

An example of the information processing apparatus 1 which includes the information processing controller 11 is a hard disk recorder. FIGS. 10 and 11 show a hardware configuration and a software configuration of the hard disk recorder shown in FIG. 9, respectively. Referring to FIG. 10, the information processing apparatus 1 shown includes, as the hardware configuration thereof, a built-in hard disk serving as the external recording section 28-1 shown in FIG. 1. The information processing apparatus 1 further includes the external recording section 28-2 shown in FIG. 1 into which an optical disk such as DVD±R/RW, CD±R/RW, a Bluray-Disc (registered trademark) and so forth can be loaded. The information processing apparatus 1 further includes a broadcast reception section 32-1, an image inputting section 33-1, a sound inputting section 34-1, an image outputting section 35-1, a sound outputting section 36-1, an operation panel section 37-1, a remote control light reception section 38-1 and a network connection section 39-1 connected to a bus 31-1 which is in turn connected to the bus 29-1 of the information processing controller 11.

The broadcast reception section 32-1, image inputting section 33-1 and sound inputting section 34-1 receive a broadcasting signal or an image signal and a sound signal from the outside of the information processing apparatus 1, convert the received signal or signals into digital data of a predetermined format, and signals the digital data to the bus 31-1 so as to be processed by the information processing controller 11. The image outputting section 35-1 and the sound outputting section 36-1 process image data and sound data signaled from the information processing controller 11 to the bus 31-1 and signal the image data and the sound data as they are or after converted into analog signals to the outside of the information processing apparatus 1. The remote control light reception section 38-1 receives a remote control infrared signal from a remote control transmitter 43-1.

As seen in FIGS. 9 and 10, a monitor display apparatus 41 and a speaker apparatus 42 are connected to the image outputting section 35-1 and the sound outputting section 36-1 of the information processing apparatus (hard disk recorder) 1, respectively.

Also the information processing apparatus 2 which includes the information processing controller 12 shown in FIG. 9 is a hard disk recorder and is configured similarly to the information processing apparatus 1 as seen in FIG. 10 in which reference numerals are applied in parentheses. However, a monitor display apparatus and a speaker apparatus are not connected to the information processing apparatus (hard disk recorder) 2 as seen in FIG. 9.

The information processing apparatus (hard disk recorders) 1 and 2, that is, the information processing controllers 11 and 12, include, as the software configuration shown in FIG. 11, the MS manager and the capacity exchange program as the control programs. Further, the information processing controllers 11 and 12 include programs for image signal and sound recording, image and sound reproduction, material search and program recording reservation as the function programs. Furthermore, the information processing controllers 11 and 12 include programs for broadcast reception, image outputting, sound outputting, external recording section inputting/outputting and network inputting/outputting as the device drivers.

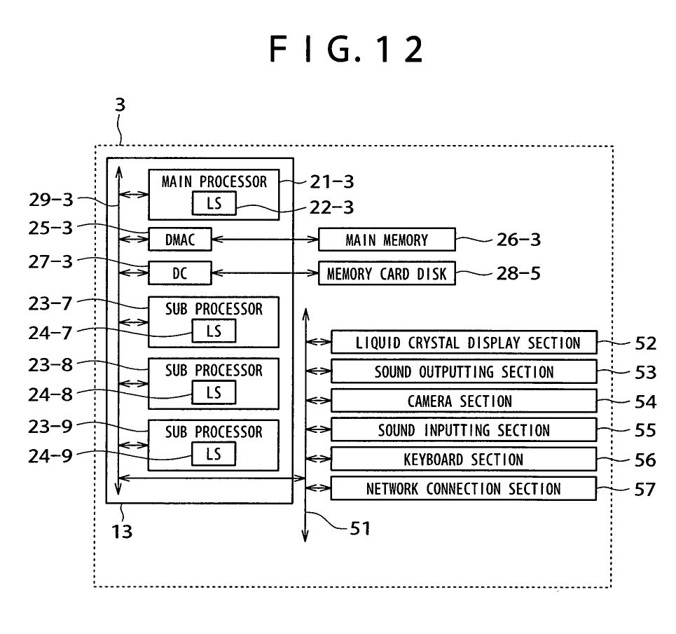

An example of the information processing apparatus 3 which includes the information processing controller 13 is a PDA (Personal Digital Assistant). FIG. 12 shows a hardware configuration of the information processing apparatus 3 formed as a PDA. Referring to FIG. 12, in the example shown, the information processing apparatus 3 includes the external recording section 28-5 shown in FIG. 1 into which a memory card disk can be loaded. The information processing apparatus 3 further includes a liquid crystal display section 52, a sound outputting section 53, a camera section 54, a sound inputting section 55, a keyboard section 56 and a network connection section 57 connected to a bus 51 which is in turn connected to the bus 29-3 of the information processing controller 13.

It is to be noted that the information processing controller 13 whose internal configuration is not shown in FIG. 1 includes a main processor 21-3, sub processors 23-7, 23-8 and 23-9, a direct memory access controller (DMAC) 25-3, a disk controller (DC) 27-3, and a bus 29-3. The main processor 21-3 includes a local storage (LS) 22-3, and the sub processors 23-7, 23-8 and 23-9 include local storages (LS) 27-7, 24-8 and 24-9, respectively.

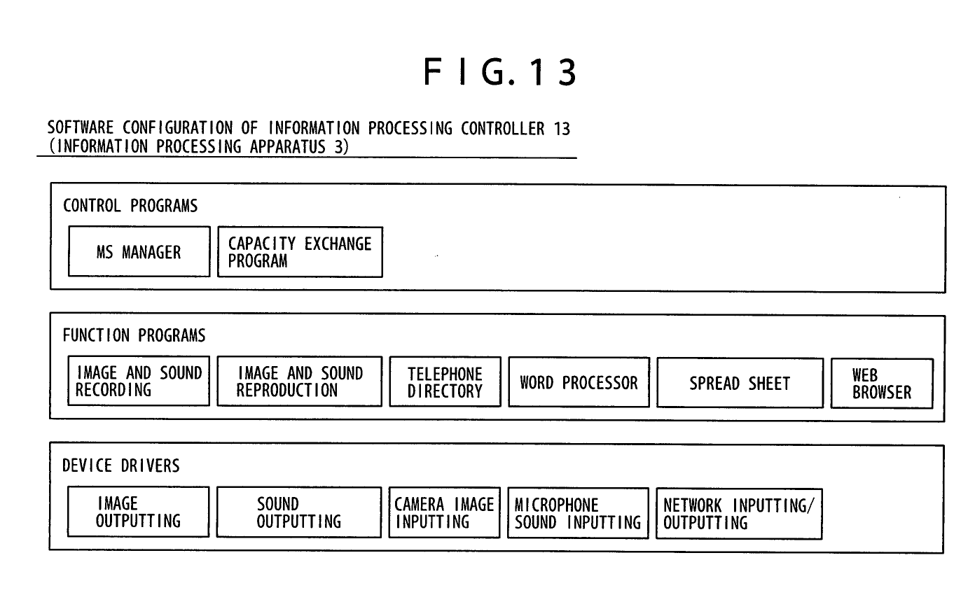

FIG. 13 shows a software configuration of the information processing apparatus (PDA) 3, that is, the information processing controller 13. Referring to FIG. 13, the information processing controller 13 includes the MS manager and the capacity exchange program as the control programs. Further, the information processing controller 13 includes programs for image and sound recording, image and sound reproduction, telephone directory, word processor and spreadsheet as the function programs, and includes a Web browser. Furthermore, the information processing controller 13 includes programs for image outputting, sound outputting, camera image inputting, microphone sound inputting and network inputting/outputting as the device drivers.

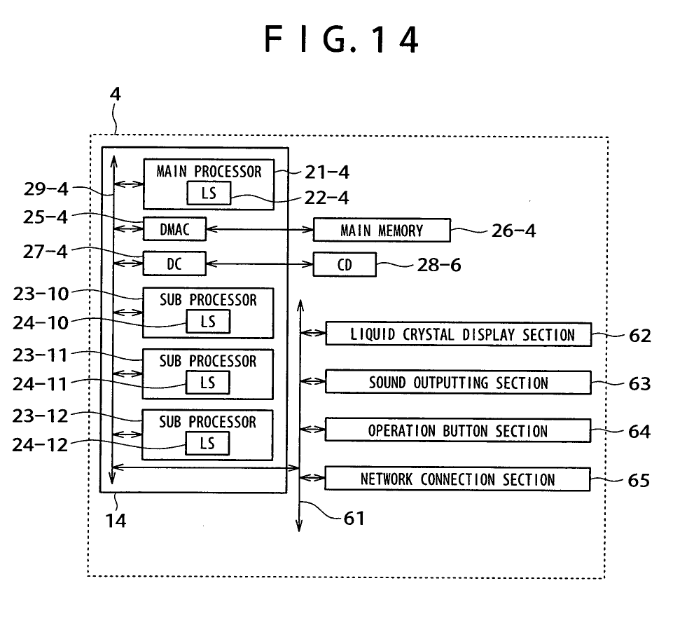

The information processing apparatus 4 which includes the information processing controller 14 is a portable CD player. FIG. 14 shows a hardware configuration of a portable CD player. Referring to FIG. 14, the portable CD player includes the external recording section 28-6 shown in FIG. 1 into which a CD (Compact Disc) can be loaded. The portable CD player further includes a liquid crystal display section 62, a sound outputting section 63, an operation button section 64 and a network connection section 65 connected to a bus 61 which is in turn connected to the bus 29-4 of the information processing controller 14.

It is to be noted that, the information processing controller 14 whose internal configuration is not shown in FIG. 1 includes a main processor 21-4, sub processors 23-10, 23-11 and 23-12, a direct memory access controller (DMAC) 25-4, a disk controller (DC) 27-4 and a bus 29-4. The main processor 21-4 includes a local storage 22-4, and the sub processors 23-10, 23-11 and 23-12 include local storages 24-10, 24-11 and 24-12, respectively.

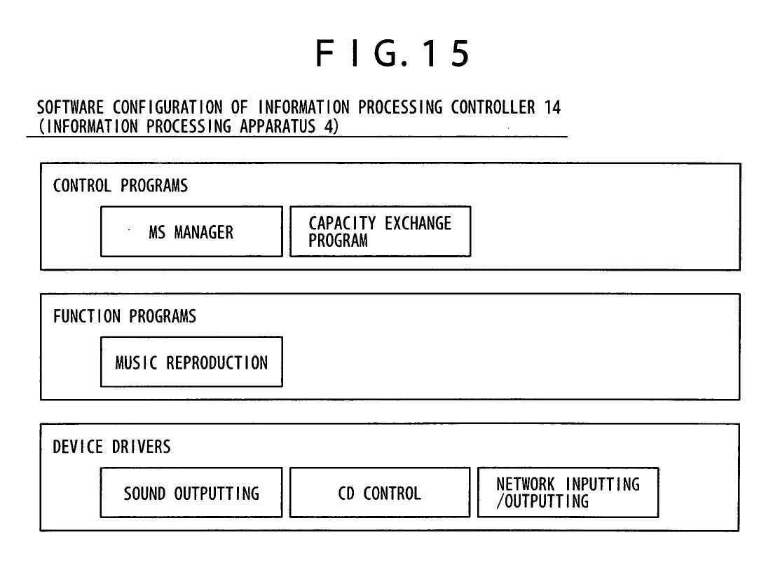

FIG. 15 shows a software configuration of the information processing apparatus (portable CD player) 4, that is, the information processing controller 14. Referring to FIG. 15, the information processing controller 14 includes the MS manager and the capacity exchange program as the control programs. Further, the information processing controller 14 includes a program for music reproduction as the function program and includes programs for sound outputting, CD control and network inputting/outputting as the device drivers.

In the network system shown in FIG. 9, the information processing apparatus 1, 3 and 4 are connected to the network 9, and the information processing apparatus 1 is set as the master apparatus (MS status=0) and the information processing apparatus 3 and 4 are set as slave apparatus (MS status=1).

If, in this state, the information processing apparatus 2 is newly connected to the network 9, then the MS manager which is executed in the main processor 21-2 included in the information processing controller 12 in the information processing apparatus 2 inquires the other information processing apparatus 1, 3 and 4 about the MS status and recognizes that the information processing apparatus 1 always exists as the master apparatus. Thus, the MS manager sets the self apparatus (information processing apparatus 2) as a slave apparatus (MS status=1). Meanwhile, the information processing apparatus 1 set as the master apparatus collects the apparatus information of the apparatus including the newly added information processing apparatus 2 and updates the apparatus information tables in the main memory 26-1 based on the collected apparatus information.

Operation of the network system of FIG. 9 when, in this state, the user operates the information processing apparatus 3, which is a slave apparatus, for recording reservation of a broadcasting program for two hours is described below.

In this instance, the information processing apparatus 3 which is a slave apparatus accepts inputting of recording reservation information including information of recording start time, recording end time, a recording object broadcast channel and a recording picture quality, and produces a software cell including the recording reservation information and the recording reservation command as the DMA command. Then, the information processing apparatus 3 transmits the produced software cell to the information processing apparatus 1 which is the master apparatus.

The main processor 21-1 included in the information processing controller 11 in the information processing apparatus 1 which receives the software cell whose DMA command is the recording reservation command reads out the recording reservation command and refers to the apparatus information tables in the main memory 26-1 to specify an information processing apparatus which can execute the recording reservation command.

First, the main processor 21-1 reads out the information processing apparatus type IDs of the information processing apparatus 1, 2, 3, and 4 included in the apparatus information tables to extract those information processing apparatus that can execute a function program corresponding to the recording reservation command. Here, the information processing apparatus 1 and 2 having the information processing apparatus type ID indicative of the recording function are specified as candidate apparatus while the information processing apparatus 3 and 4 are excepted from candidate apparatus.

The main processor 21-1 included in the information processing controller 11 in the information processing apparatus 1 as the master apparatus refers to the apparatus information tables. Then, the main processor 21-1 reads out information regarding the apparatus such as the processing capacities of the main processors and sub processors and information regarding the main memories of the information processing apparatus 1 and 2 and discriminates whether or not the information processing apparatus 1 and 2 satisfy the required specifications necessary for execution of the function program corresponding to the recording reservation command. It is assumed here that both of the information processing apparatus 1 and 2 satisfy the required specifications necessary for execution of the function program corresponding to the recording reservation command.

Further, the main processor 21-1 refers to the apparatus information tables to read out the information regarding external recording sections of the information processing apparatus 1 and 2, and discriminates whether or not the free capacities of the external recording sections satisfy the capacity necessary for execution of the recording reservation command. Since the information processing apparatus 1 and 2 are hard disk recorders, the differences between the total capacities and the used capacities of the external recording sections 28-1 and 28-3 individually correspond to the free capacities.

In this instance, it is assumed that the free capacity of the external recording section 28-1 of the information processing apparatus 1 is 10 minutes when it is converted into a recording period of time and the free capacity of the hard disk 28-3 of the information processing apparatus 2 is 20 hours when it is converted into a recording period of time.

In this instance, the main processor 21-1 included in the information processing controller 11 in the information processing apparatus 1 which is the master apparatus specifies the information processing apparatus which can secure the free capacity for two hours necessary for execution of the recording reservation command as a slave apparatus of a destination of an execution request.

As a result, only the information processing apparatus 2 is selected as the execution request destination slave apparatus, and the main processor 21-1 included in the information processing controller 11 in the information processing apparatus 1 which is the master apparatus transmits the recording reservation command including the recording reservation information transmitted from the information processing apparatus 3 operated by the user to the information processing apparatus 2 to request the information processing apparatus 2 for recording reservation of the broadcast program for two hours described hereinabove.

Then, the main processor 21-2 included in the information processing controller 12 in the information processing apparatus 2 analyzes the recording reservation command and loads a function program necessary for recording from the hard disk 28-3, which is an external recording section, into the line memory 26-2. Then, the main processor 21-2 executes recording in accordance with the recording reservation information. As a result, image and sound data of the broadcast program for two hours reserved for recording are recorded on the hard disk 28-3 of the information processing apparatus 2.

In this manner, also in the network system shown in FIG. 9, the user can cause the plural information processing apparatus 1, 2, 3 and 4 to operate as a virtual single information processing apparatus 7 only by operating only one of the information processing apparatus without operating any other one of the information processing apparatus.

B. Implementation of an Expanded Function of a Virtual Single Information Processing Apparatus

As described above, according to the present invention, a virtual single information processing apparatus can be implemented through cooperation of a plurality of information processing apparatus connected to each other by a network.

According to another embodiment of the present invention, at least one of information processing apparatus composing a virtual single information processing apparatus has an open area formed on a physical storage space of a physical storage apparatus thereof such that it allows use of the open area by a different one of the information processing apparatus. The physical storage apparatus includes a main memory and other local memories, an external storage apparatus such as a hard disk, and an I/O space to which inputting and outputting to and from different apparatus locally connected to the self apparatus are allocated. Thus, such information resources as mentioned above can be shared by the information processing apparatus, which cooperate with each other.

Such sharing of information resources is implemented by a predetermined handshake process relating to a request and a permission response between an information processing apparatus requesting for an open area and another information processing apparatus providing an open area. The handshake procedure may include a process for mutual authentication between such information processing apparatus and so forth.

Each of the information processing apparatus includes one or more physical storage apparatus as described hereinabove. Normally, the physical storage space of each physical storage apparatus, that is, the physical segment address, is mapped to a logical storage space, that is, a virtual address space such that execution of a process is performed on the physical address space. In the present embodiment, if an information processing apparatus is permitted to use an open area from a different information processing apparatus, then the information processing apparatus maps and uses the open area existing in the physical address space of the different information processing apparatus to and together with the virtual address space of the self apparatus. In other words, the information processing apparatus maps and uses the physical segment addresses of the open area obtained from the different information processing apparatus to and together with the virtual segment address of the virtual address space of the self apparatus.

The mechanism of the segment conversion is such as described below. In particular, an information processing apparatus providing an open area to different information processing apparatus allocates open area addresses to physical segment addresses allocated to the open area on the physical storage space thereof. Each of the open area addresses is represented, on the network, that is, on the virtual information processing apparatus, as a combination of a destination ID formed from an information processing apparatus ID for uniquely identifying an information processing apparatus and an open area address on the information processing apparatus. On the other hand, an information processing apparatus that uses an open area provided by a different information processing apparatus converts an address representation formed from a combination of a destination ID and an open area address on the information processing apparatus itself into a virtual segment address.

The segment conversion sections of both of the information processing apparatus providing an open area and the information processing apparatus using the open area operate cooperatively through a network. Accordingly, the information processing apparatus using the open area can use only a virtual segment address to access both of the local memory in the self apparatus and the open area of the different information processing apparatus equivalently to each other. In other words, the open area disposed remotely through the network is handled equivalently such that it can be accessed without any distinction from a local memory in the self apparatus.

For example, if a certain information processing apparatus issues an access request to an open area of a different information processing apparatus mapped in the virtual address space, then the virtual segment address of an object of the access request is converted into an address representation including a destination ID and an open area address, and the access request is issued to the information processing apparatus designated by the destination ID.

The information processing apparatus receiving the access request converts the open area address into a physical segment address in the self apparatus and can acquire data from the pertaining physical segment. Thereafter, the physical segment is converted into an open area address, and data obtained with the destination ID and the open area address is returned to the information processing apparatus of the request source. The information processing apparatus of the request source converts the destination ID and the open area address into a virtual segment address and returns the virtual segment address as data obtained from the virtual segment to the application of the request source and so forth.

It is to be noted that an information processing apparatus having an open area formed therein may divide the open area thereof and issues a permission of use simultaneously to a plurality of different information processing apparatus. Further, an information processing apparatus may issue a request for use of open areas formed by two or more different information processing apparatus and simultaneously use the open areas of the two or more information processing apparatus whose use is permitted.

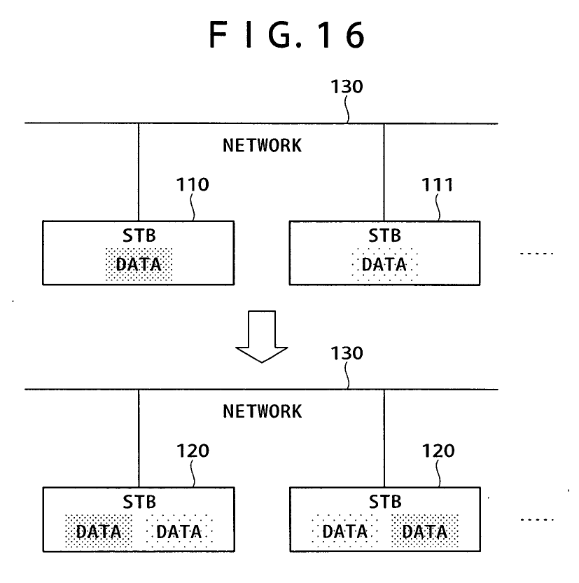

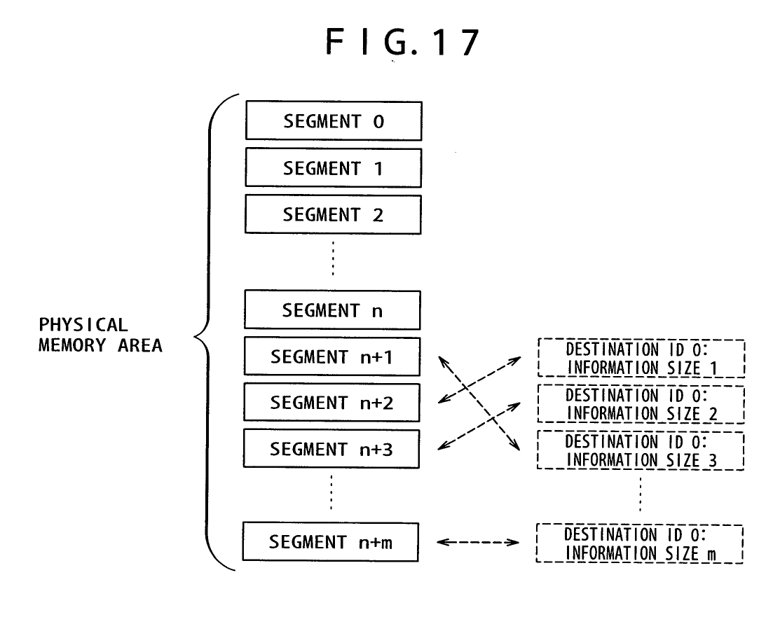

FIG. 16 schematically shows a configuration of a network system according to another embodiment of the present invention.

Referring to FIG. 16, in the network system shown, a plurality of information processing apparatus 110, 111, . . . such as set top boxes (STB) and AV apparatus connected to each other by a local area network 130 such as a home network cooperate with each other to construct a single virtual information processing apparatus 120. In such an instance, if information retained in a distributed manner in two or more of the information processing apparatus 110 and 111 is placed in an open area, then as viewed from a user, the information can be handed as information retained virtually by a single apparatus.

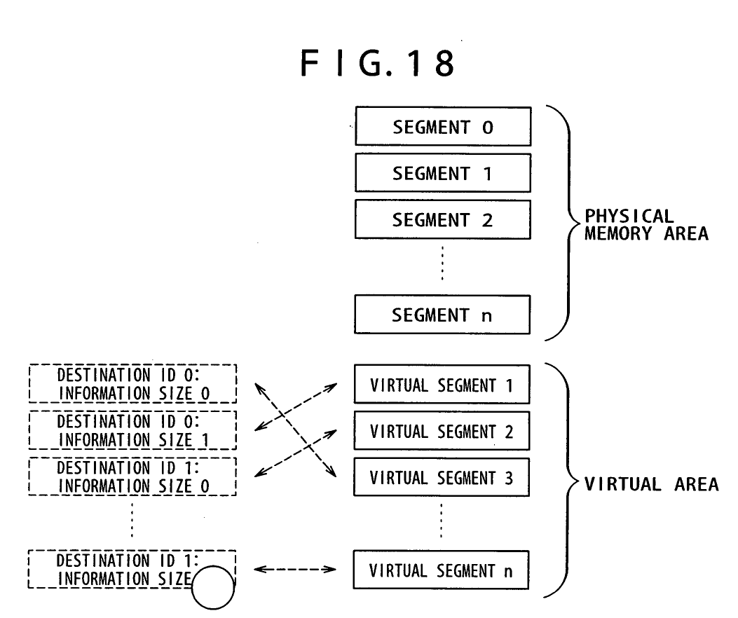

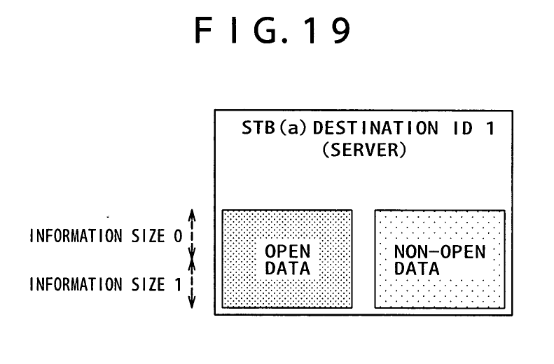

Now, a process of an information processing apparatus for forming an open area is described with reference to FIGS. 18 and 19.

An information processing apparatus allocates an unused area of the main memory, which is not used, for example, by an operating system, to an open area. Then, the information processing apparatus allocates open area addresses to physical segment addresses allocated to the open area on the main memory. Each of the open area addresses is represented as a combination of a destination ID and an information size number on the network, that is, on the virtual information processing apparatus. The destination ID is formed from an information processing apparatus ID for uniquely identifying an information processing apparatus.

On the other hand, an information processing apparatus having no unused area in the main memory thereof issues a request for use of an open area to a different information processing apparatus. If the request for use is permitted and an open area can be acquired, then the information processing apparatus converts open area addresses each formed from a combination of a destination ID and an information size number into virtual segment addresses and places the open area into the virtual address space. As a result, on the information processing apparatus, the open area disposed remotely through the network becomes equivalent. Consequently, the information processing apparatus can access the open area without any distinction from the physical memory thereof.

For example, if an apparatus such as a server, which manages various data including open data and non-open data, retains open data in an open area, then sharing of information with the different information processing apparatus, which operate virtually as a single apparatus through cooperation with the information processing apparatus, can be implemented readily (refer to FIG. 19). In particular, the server opens information and an area thereof to a client, and the client can read out the information or area opened by the server and use the read out information in execution of processing thereof. Also it is possible for a client to serve as a representative server and open information or an area thereof to different clients.

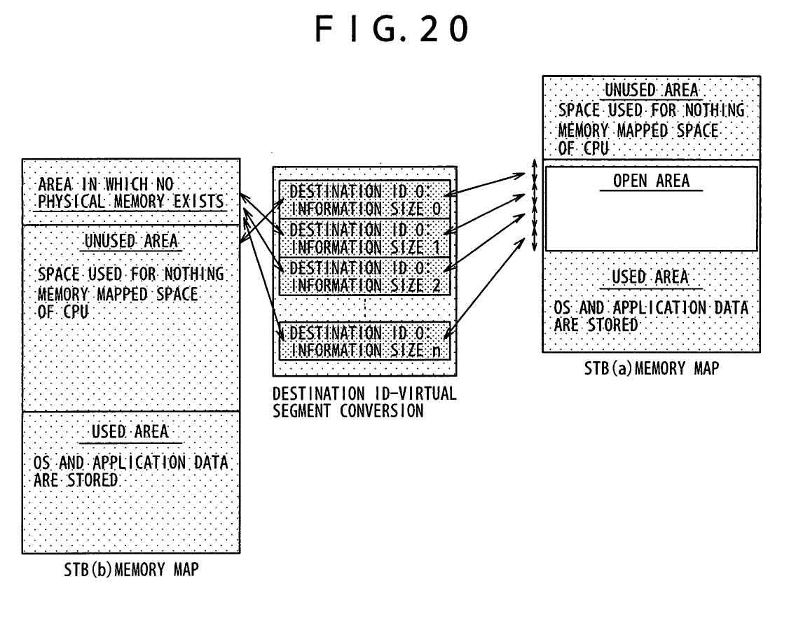

FIG. 20 illustrates a manner wherein one of two set top boxes (STB: STB(a) and STB(b)), which are connected to a network and cooperate with each other, that is, a set top box STB(a) serves as a server while the other set top box STB(b) serves as a client. Information of the set top box STB(b) is mapped in the set top box STB(a).

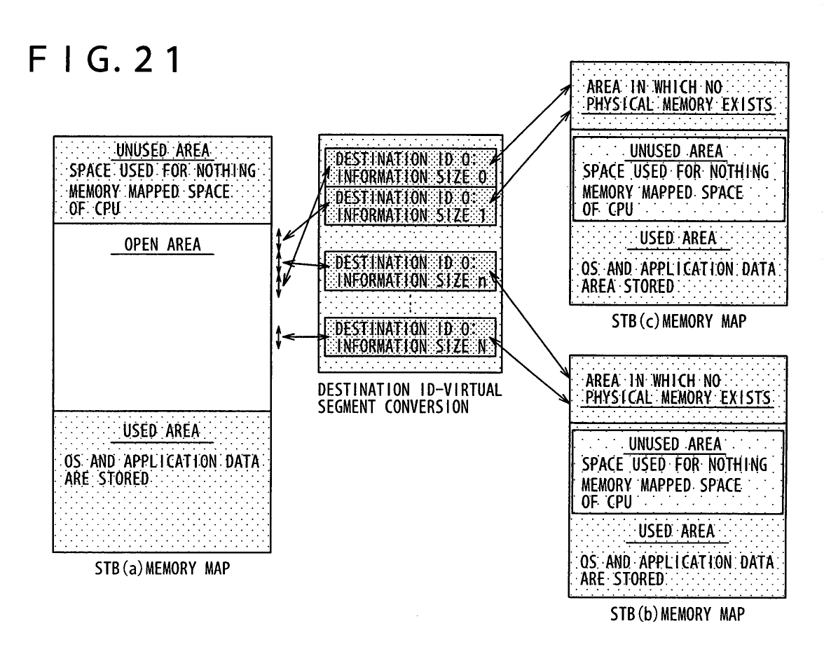

An information processing apparatus forming an open area may divide the open area thereof such that a permission of use is provided simultaneously to a plurality of different information processing apparatus. FIG. 21 illustrates a manner wherein a set top box STB(a) permits use of the open area thereof to two set top boxes STB(b) and STB(c).

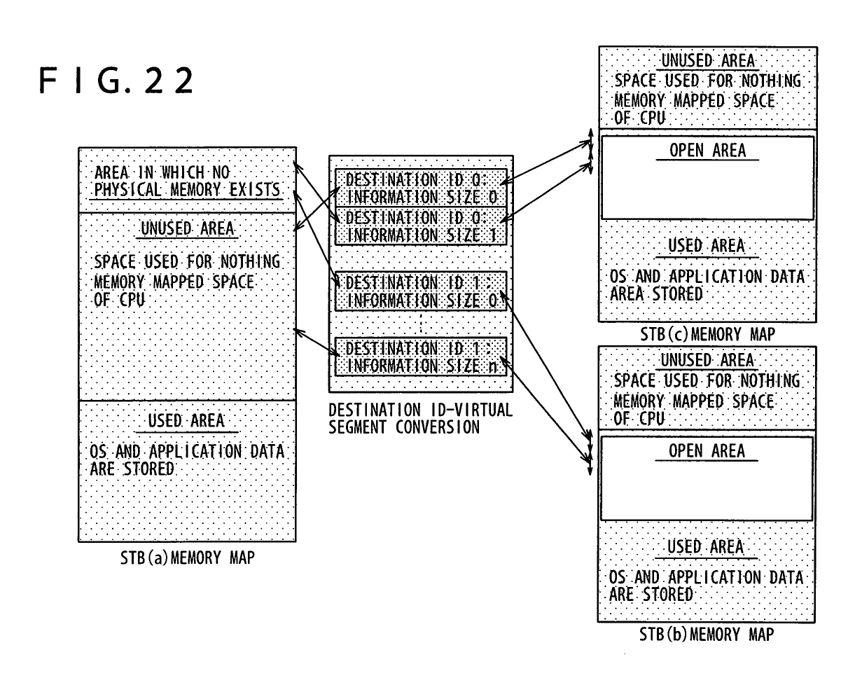

Further, an information processing apparatus may issue a request for use of open areas formed by two or more different information processing apparatus and use the open areas of the two or more information processing apparatus whose use is permitted. FIG. 22 illustrates a manner wherein a set top box STB(b) uses open areas whose use is permitted from two set top boxes STB(a) and STB(c).

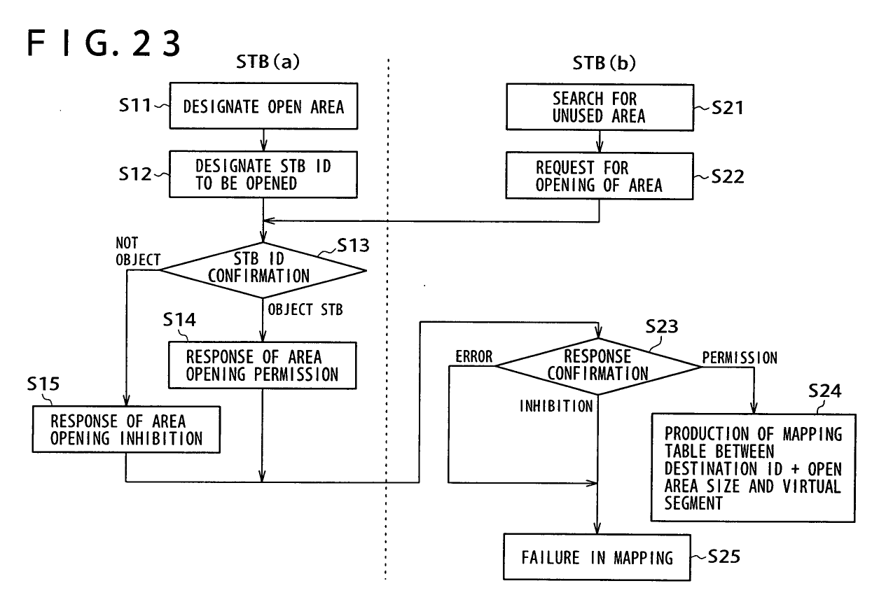

Such sharing of information resources as described above by information processing apparatus, which cooperate with each other to form a single virtual information processing apparatus, is implemented by a predetermined handshake procedure regarding a request and a permission response between an information processing apparatus requesting for an open area and another information apparatus providing an open area. The handshake procedure is described with reference to FIG. 23.

The set top box STB(a) providing an open area sets an area to be opened on the memory space and an information processing apparatus ID of a destination of opening in advance (steps S11 and S12).

The set top box STB(b) trying to use an open area checks an unused area (step S21).

Then, the set top box STB(b) issues an area opening request to the set top box STB(a) (step S22). The area opening request describes a memory size to be used.

In response to the request, the set top box STB(a) performs an authentication process based on the information processing apparatus ID of the set top box STB(b) whether or not the set top box STB(b) is an opening destination set in advance (step S13).

Here, if the set top box STB(b) is an object opening destination, then the set top box STB(a) returns an area opening permission response (step S14). In this instance, the set top box STB(a) produces a mapping table between the physical segment addresses of the open area formed in the physical memory space of the self apparatus and the open area addresses each of which is formed from a destination ID and an opening area size.

On the other hand, if the set top box STB(b) is not an object opening destination, then the set top box STB(a) returns an area opening inhibition response to the set top box STB(b) (step S15).

The set top box STB(b) checks whether the request response from the set top box STB(a) indicates permission or inhibition (step S23). If the response indicates permission, then the set top box STB(b) produces a mapping table between the open area addresses each of which is formed from a destination ID and an open area size and the virtual segments allocated in the open area in the virtual memory space (step S24). On the other hand, if the request response indicates inhibition or if an error occurs with the response, then the set top box STB(b) determines that the mapping results in failure and abnormally ends (abends) the processing routine (step S25).

The mapping table between the destination ID+open area size and the virtual segment is formed by conversion of a destination ID indicative of an information processing apparatus, which is the source of provision of the open area, and the data length into an address number on the virtual address space, that is, a virtual segment address.

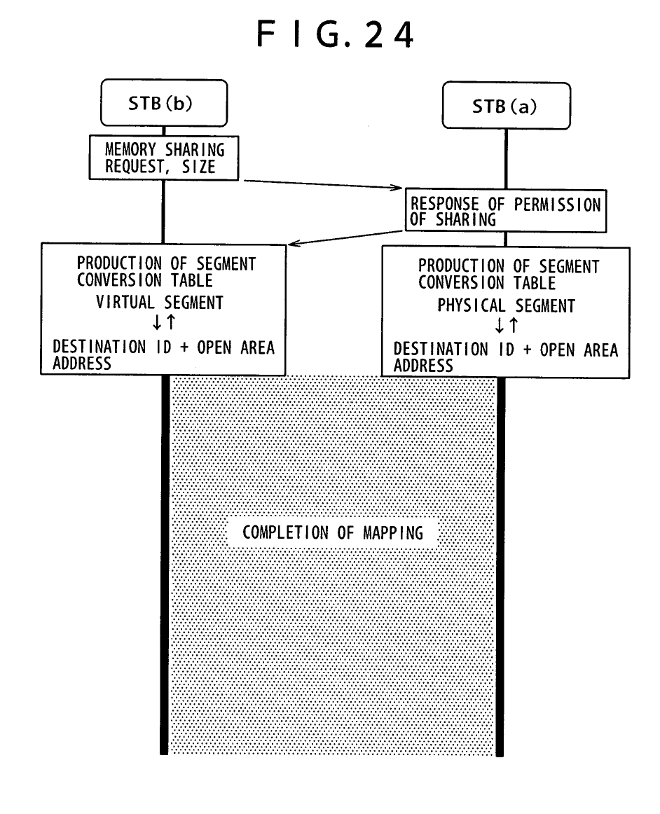

FIG. 24 illustrates an operation sequence. When use of an open area is permitted between the set top boxes STB(a) and STB(b) in accordance with the handshake procedure described above with reference to FIG. 23, an open space on the physical memory space of the set top box STB(a) is allocated to the virtual memory space of the set top box STB(b).

The set top box STB(b) issues an area opening request to the set top box STB(a) designating a memory size to be used, and the set top box STB(a) issues a permission response.

The set top box STB(a) produces a mapping table between the physical segment addresses of the open area formed in the physical memory space of the self apparatus and the open area addresses each formed from a destination ID and an open area size.

The set top box STB(b) produces a mapping table between the open area addresses each formed from a destination ID and an open area size and the virtual segments allocated to the open areas in the virtual memory space.

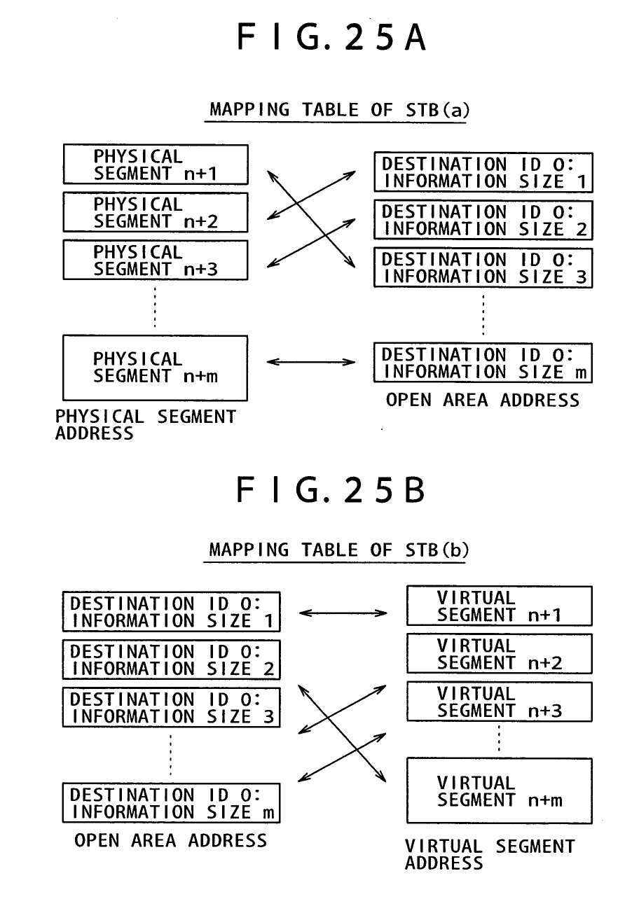

FIGS. 25A and 25B schematically illustrate configurations of mapping tables. Referring to FIG. 25A, the mapping table of the set top box STB(a) describes a corresponding relationship between the physical segment addresses of the open area formed in the physical memory space of the self apparatus and the open area addresses each formed from a destination ID and an open area size. Meanwhile, FIG. 25B, the mapping table of the set top box STB(b), describes a corresponding relationship between the open area addresses each formed from a destination ID and an open area size and the virtual segments allocated to the open areas in the virtual memory space of the self apparatus.

Where such mapping tables as described above are referred to, the set top box STB(b) can handle information of the set top box STB(a), which provides an open area, as if the information were information on the main memory or an external storage apparatus of the self apparatus. Meanwhile, the set top box STB(a) can acquire data from a pertaining physical segment address in accordance with an access request designating an open area address and returns the acquired data to the request source.

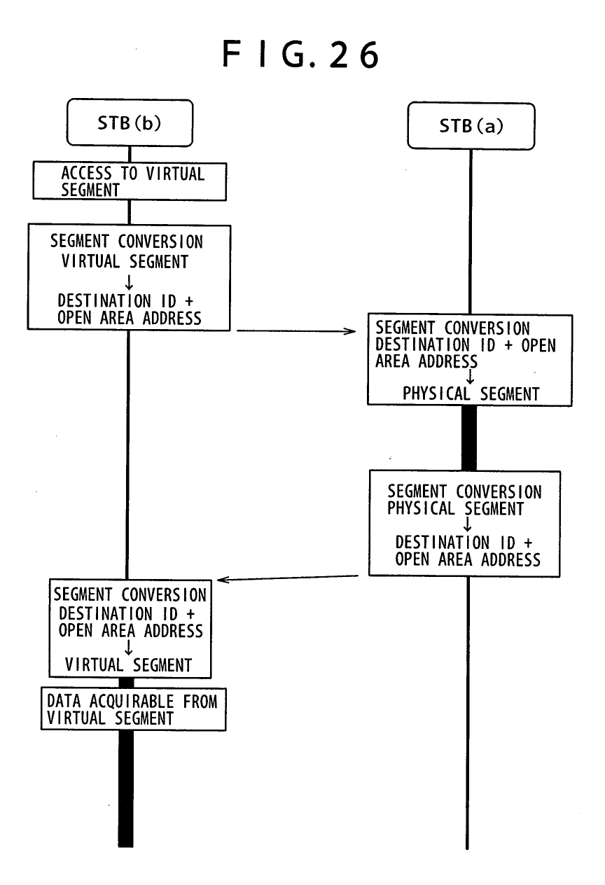

FIG. 26 illustrates an operation sequence performed by the set top box STB(b) to access an open area of the set top box STB(a).

If an access request to an open area of the set top box STB(a) mapped in the virtual address space is generated in the set top box STB(b), then the set top box STB(b) first converts a virtual segment address of an object of the accessing request into an open area address representation including a destination ID and a segment number. Then, the set top box STB(b) issues an access request to the set top box STB(a) designated with the destination ID.

The set top box STB(a) recognizes based on the destination ID of the open area address that the access request is directed to an open area of the self apparatus, and converts the segment number of the open area address into a physical segment address. Then, the set top box STB(a) acquires data from the pertaining physical segment. Then, the set top box STB(a) converts the physical segment address back into an open area address including a destination ID and a segment number and returns the open area address as data acquired with the destination ID and the open area address to the set top box STB(b) of the request source.

The information processing apparatus STB(b) converts the destination ID and the open area address into a virtual segment address and returns the virtual segment address as data acquired from the virtual segment to the application of the request source and so forth.

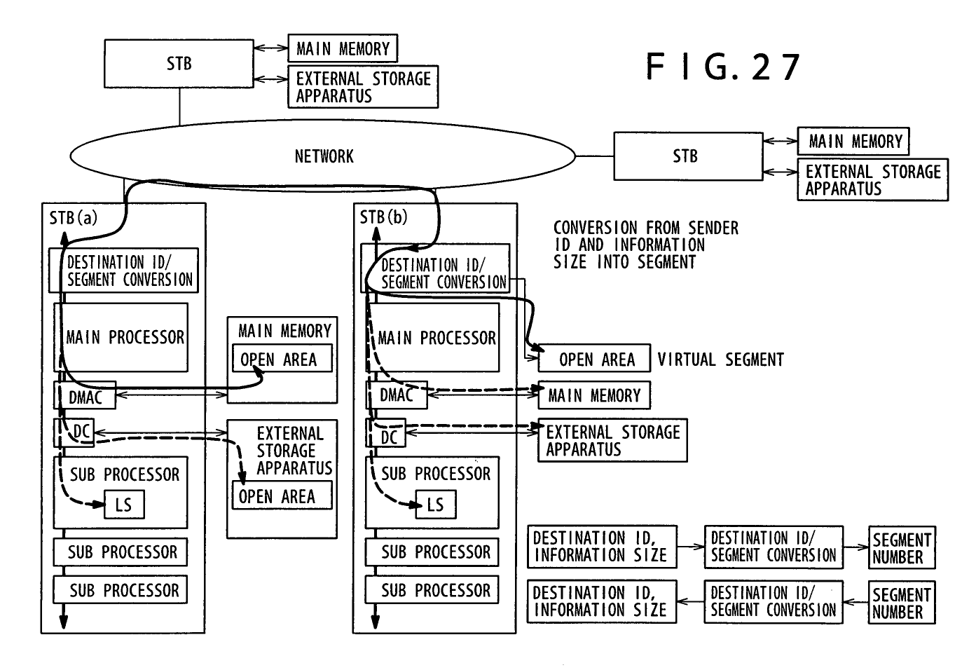

FIG. 27 illustrates a memory access procedure of the set top box STB(b). A mechanism for accessing an open area of a memory based on a segment conversion mechanism is described with reference to FIG. 27.

It is assumed that an access request, for example, from a program operating in the main processor or a program operating in a sub processor to data is generated in the set top box STB(b). The data here includes both of a program code and data used by the program code.

The access request for data is performed normally designating a virtual segment address. The virtual segment address is converted into a physical segment address, and if the physical segment address represents an address on the main memory, then the direct memory access controller (DMAC) is utilized to perform memory accessing to acquire data from the pertaining physical memory segment.

On the other hand, if the virtual segment address of the object of the access request for data represents a segment (sector) on an external storage apparatus such as a hard disk, the disk controller (DC) is utilized to access a disk to acquire data from the pertaining disk.

Further, if the virtual segment address of the object of the access request for data represents a physical segment address on a local memory of a sub processor, the local memory is accessed through the pertaining sub processor to acquire data from the pertaining physical memory segment.

On the other hand, if the virtual segment address of the object of the access request for data represents an open area address, then the destination ID/segment conversion section converts the virtual segment address of the object of the access request into an open area address representation including a destination ID and a segment number. Then, an access request is issued to the set top box STB(a) designated by the destination ID.

On the other hand, the set top box STB(a) recognizes based on the destination ID of the open area address that the access request received is directed to an open area in the self apparatus, and the destination ID/segment conversion section converts the segment number of the open area address of the object of the access request into a physical segment address.

If the physical segment address represents a segment on the main memory, then the direct memory access controller (DMAC) is used to perform memory accessing to acquire data from the pertaining physical memory segment.

If the virtual segment address of the object of the access request to data represents a segment (sector) on an external storage apparatus such as a hard disk, the disk controller (DC) is utilized to perform memory accessing to acquire data from the pertaining sector.

Then, the destination ID/segment conversion section converts the physical segment address back into an open area address including a destination ID and a segment number and returns data acquired with the destination ID and the open area address to the set top box STB(b) of the request source.

On the set top box STB(b) side, the destination ID/segment conversion section converts the destination ID and the open area address into a virtual segment address and returns the virtual segment address as data acquired from the virtual segment to the program of the request source.

In this manner, since the destination ID/segment conversion sections of the set top boxes STB(a) and STB(b), which cooperate with each other through the network and act as a single virtual information processing apparatus, cooperatively operate with each other on the network, the open area of the set top box STB(a) used by the set top box STB(b) becomes equivalent and can be accessed without any distinction from the physical memory in the self apparatus.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. An information processing system, comprising:
a plurality of information processing apparatuses connected to each other by a network in such a manner as to cooperate with each other to virtually form a single virtual information processing apparatus; wherein,
each information processing apparatus comprises a physical storage apparatus, and
at least one of said information processing apparatuses being operable to form, on a physical storage space of said physical storage apparatus thereof, an open area whose use is permitted to a different information processing apparatus and permit use of the open area in response to a request for use of the open area from any of the different information processing apparatuses.

2. The information processing system according to claim 1, wherein the information processing apparatus having the open area formed therein can permit use of the open area to two or more open areas associated with the different information processing apparatus.

3. The information processing system according to claim 1, wherein each of said information processing apparatus can issue a request for use of open areas formed by two or more of the different information processing apparatus and simultaneously use the open areas of those of the two or more different information processing apparatus whose use is permitted.

4. The information processing system according to claim 1, wherein each of said information processing apparatus includes one or more physical storage apparatuses and a storage space conversion section for mapping a physical storage space of each of the physical storage apparatus in a logical storage space and executes a process based on the logical storage space or spaces, and said storage space conversion section of each of said information processing apparatuses maps a physical storage space of an open area whose use is permitted from any of a different information processing apparatus to the logical storage space of the information processing apparatus.

5. The information processing system according to claim 4, wherein the first storage space conversion section of the first information processing apparatus which provides an open area to the different information processing apparatus allocates an open area address to a physical address of the open area on the physical storage space, and the second storage space conversion section of the second information processing apparatus which uses the open area provided by the first information processing apparatus allocates a logical address on the logical storage space to an open area address of the open area.

6. The information processing system according to claim 5, wherein, when the second information processing apparatus issues an access request to the open area of the first information processing apparatus mapped in the logical storage space, the second storage space conversion section converts the logical access of an object of the access request into an open area address, and said first storage space conversion section converts the open area address into a physical address of the first information storage apparatus to access the physical storage space.

7. The information processing system according to claim 6, wherein the first storage space conversion section returns data acquired from a physical address allocated to the open area as data on the open address to the second storage space conversion section, and the second storage space conversion section returns the data on the open address as data on the logical address to the source of the access request.

8. The information processing system according to claim 1, wherein each of said information processing apparatus forms an open area in a space of said physical storage apparatus which is not used by an operating system.

9. The information processing system according to claim 1, wherein each of said information processing apparatus forms an open area on a memory space of a main memory used by a processor or a local memory locally connected to said processor.

10. The information processing system according to claim 1, wherein each of said information processing apparatus forms an open area on a storage space of an external storage apparatus locally connected thereto.

11. The information processing system according to claim 1, wherein each of said information processing apparatus forms an open area on an input/output storage space to which inputting from or outputting to each apparatus locally connected to the information processing apparatus is allocated.

12. An information processing apparatus which operates as a component of a single virtual information processing apparatus formed through cooperation of said information processing apparatus with one or more different information processing apparatus connected thereto through a network, comprising:
a physical storage space;
an open area formed on said physical space for permitting use thereof by the different information processing apparatus; and
an open area use control section for permitting use of said open area in response to a request for use of said open area from any of the different information processing apparatus.

13. The information processing apparatus according to claim 12, further comprising an open area use requesting section for issuing a request for use of an open area of any of the different information processing apparatus.

14. The information processing apparatus according to claim 13, wherein said physical storage space is formed from one or more physical storage apparatus, said information processing apparatus further comprising a storage space conversion section for mapping a physical storage space of each of the different physical storage apparatus in said logical storage space, said information processing apparatus executing a process based on the logical storage space or spaces, said storage space conversion section allocating an open area address to a physical address of the open area whose use is permitted to any of the different apparatus, said storage space conversion section further allocating a logical address to an open area address whose use is permitted from any of the different apparatus.

15. The information processing apparatus according to claim 14, wherein, when an access request to an open area is received from any of the different information processing apparatus, said storage space conversion section converts the open area address of an object of the access request into a physical address and returns data extracted from the physical address of said physical storage space as data on the open area address.

16. The information processing apparatus according to claim 14, wherein, where the logical address of an object of the access request is an address in the open area whose use is permitted from any of the different information processing apparatus, said storage space conversion section converts the logical address of the object of the access request into an open area address and issues an access request to the pertaining different information processing apparatus, and then converts data on the open area address returned from the pertaining different information processing apparatus into a logical address and returns the logical address to the source of the access request.

17. The information processing apparatus according to claim 12, wherein the open area is formed in a space of said physical storage apparatus which is not used by an operating apparatus.

18. The information processing apparatus according to claim 12, wherein the open area is formed on a memory space of a main memory used by a processor or a local memory locally connected to said processor.

19. The information processing apparatus according to claim 12, wherein the open area is formed on a storage space of an external storage apparatus locally connected thereto.

20. The information processing apparatus according to claim 12, wherein the open area is formed on an input/output storage space to which inputting from or outputting to each apparatus locally connected thereto is allocated.

21. An information processing method for causing an information processing apparatus to operate as a component of a single virtual information processing apparatus formed through cooperation of said information processing apparatus with one or more different information processing apparatus connected thereto through a network, said information processing apparatus having a physical storage space on which an open area for permitting use thereof by the different information processing apparatus is formed, said information processing method comprising the steps of:
permitting use of said open area to any of the different information processing apparatus;
allocating an open area address to a physical address of the open area whose use is to be permitted to any of the different information processing apparatus;
converting, when an access request to the open area is received from any of the different information processing apparatus, the open area address of an object of the access request into a physical address; and
returning data extracted from the physical address of the physical storage space as data on the open area address.

22. An information processing method for causing an information processing apparatus to operate as a component of a single virtual information processing apparatus formed through cooperation of said information processing apparatus with one or more different information processing apparatus connected thereto through a network, any of said different information processing apparatus having an open area formed on a physical storage space thereof, said information processing method comprising the steps of:
issuing a request for use of said open area to the pertaining different information processing apparatus;
allocating, in response to permission of the request for use, a logical address to an open area address whose use is permitted;
converting, when a logical address of an object of an access request corresponds to the open area whose use is permitted from the pertaining different information processing apparatus, the logical address of the object of the access request into an open area address and issuing an access request to the pertaining different information processing apparatus; and
converting data on the open area address returned from the pertaining different information processing apparatus into a logical address and returning the logical address to the source of the access request.

23. A computer program described in a computer-readable form for causing a computer system to execute a process for allowing an information processing apparatus to operate as a component of a single virtual information processing apparatus formed through cooperation of said information processing apparatus with one or more different information processing apparatus connected thereto through a network, said information processing apparatus having a physical storage space on which an open area for permitting use thereof by the different information processing apparatus is formed, said computer program comprising the steps of:
permitting use of said open area to any of the different information processing apparatus;
allocating an open area address to a physical address of the open area whose use is to be permitted to any of the different information processing apparatus;
converting, when an access request to the open area is received from any of the different information processing apparatus, the open area address of an object of the access request into a physical address; and
returning data extracted from the physical address of the physical storage space as data on the open area address.

24. A computer program described in a computer-readable form for causing a computer system to execute a process for allowing an information processing apparatus to operate as a component of a single virtual information processing apparatus formed through cooperation of said information processing apparatus with one or more different information processing apparatus connected thereto through a network, any of said different information processing apparatus having an open area formed on a physical storage space thereof, said computer program comprising the steps of:
issuing a request for use of said open area to the pertaining different information processing apparatus;
allocating, in response to permission of the request for use, a logical address to an open area address whose use is permitted;
converting, when a logical address of an object of an access request corresponds to the open area whose use is permitted from the pertaining different information processing apparatus, the logical address of the object of the access request into an open area address and issuing an access request to the pertaining different information processing apparatus; and
converting data on the open area address returned from the pertaining different information processing apparatus into a logical address and returning the logical address to the source of the access request.
